(19) United States
(12) Patent Application Publication
(10) Pub. No.: US 2009/0074919 A1
(43) Pub. Date: Mar. 19, 2009

(54) American school lunch meals

(75) Inventor: Leon Curtis Smith, Dallas, TX (US)

Correspondence Address: LEON CURTIS SMITH, 5637 EMROSE TERRANCE, DALLAS, TX, 75227, US

(73) Assignee: Leon Curtis Smith, Dallas, TX (US)

(21) Appl. No.: 11/900,445

(22) Filed: Sep. 13, 2007

(51) Int. Cl. A23L 1/303; A23L 1/302

(52) U.S. Cl. 426/73; 426/590; 426/549; 426/531; 426/586

(57) ABSTRACT

A process for designing, and flavoring a shelf stable baked meal, cereal meal, freeze dried meal, chocolate meal, caramel meal, popsicle meal, and ice cream antithesis meal by taking a commercial brand name product and improving it by adding foodstuff nutrients to make it an American meal. When combined they meet the predetermined requirements of the National School Lunch program, the United States Department and the Dash Eating plan food intake requirements as defined in present invention. The said meals takes an existing commercial product, an example is candy bar and adds the necessary foodstuff components to the candy bar such that when combined the final product meets the food intake requirements of said American meal. The method of producing shelf stable various meals comprise using existing known methods and technologies of preparing foodstuff and keeping it fresh and ready to eat until opened.

### FIELD OF INVENTION

The present invention relates, specifically, to the National School Lunch Program requirements. It also zeros in on the daily food intake requirements guidelines of the United States Department of Agriculture and Dash Food Plan. Said invention comprises a method of preparation, processing, and forming foodstuff and a commercially brand named product into shelf stable, nutritional, tasteful and flavored American meal designs. An example, is taking a “Diet Twist Up”, Soft Drink, a commercially proven brand name product, and adding the missing nutrients such that combined they meet all of the food intake requirements of the National School Lunch Program, as well as the dietary guidelines for Americans.

U.S. Pat. No. 6,716,462 to Posise, et al., issued on Apr. 6, 2004 is directed to tasty, ready to eat nutritional foods that provide a balanced mix of amino acids, fats, and carbohydrates are disclosed. Processes for making and methods of the using said tasty, ready-to-eat nutritional foods are disclosed. The nutritious foods of the invention are formulated and processed as an alternative to appealing but unhealthy snacks. U.S. Pat. No. 6,228,407 to kipplinger, et al., discloses a method and additive for enhancing the shelf life of food products. The additives comprise a combination of diluent fat with a plant-drived phytosteraol to produce a plasticized blend agent. The plasticized blend agent can be incorporated into the formulation for a wide variety of prepared food. U.S. Pat. No. 6,207,203 discloses a powder composition that provides a low fat vitamin and mineral fortified coffee drink when reconstituted with water, the nutritional composition being in the form of a soluble powder containing a instant coffee component, a protein component, a vitamin/mineral component providing at least 25% of RDI 8 oz serving and a carbohydrate component in about 140 calories per 8 oz serving.

U.S. Pat. No. 6,663,904 to Cornwell, et al., issued on Dec. 16, 2003 discloses a method of making a shelf stable soft pretzel without using a caustic bath. The method substitutes several processing steps for the caustic bath, in combination with other microbal spoilage hurdle strategies, resulting in uniformly browned, topically salted soft pretzel uniquely possessing a relatively low surface pH and long shelf life. U.S. Pat. No. 6,808,727 issued on Oct. 26, 2004 discloses an improved meal substitute food bar, herein called a meal equivalent food bar because it is divided into segments equivalent to the sequence of courses in a conventional meal.

U.S. Pat. No. 6,905,719 to Wang, et al., discloses an edible, savory smooth texture bakeable shelf stable product prepared as a three phase formulation, including an aqueous liquid phase, and a dispersed fat phase and a solid phase. The product can be applied to unbaked doughs prior to baking and retain their desired properties after baking. The product can also be packaged for use as is with any number of complimentary foods. U.S. Pat. No. 7,220,442 issued on May 22, 2007, discloses a method of making a nutrition bar which incorporates protein in the form of nuggets having high levels of selected proteins. By use of the nuggets of the invention, nutrition bars are formulated to have elevated levels of protein, yet taste and other organolepetic properties. The nuggets according to the invention include greater than 50 wt % of non soy protein selected from a group consisting of milk protein, rice protein pea protein, especially between 51 wt % and 99 wt %, more preferably between 52 wt % and 95 wt %, most preferably 55 wt % or above.

U.S. Pat. No. 6,335,282 to Mori, et al., discloses a dough composition containing not less than 15 units of a raw starch decomposing enzyme per kilogram of a raw material to be cooked, which may farther contain glucose oxidase and/or hemicelluase. The characteristics of the dough composition are improved to provide baked products which have softness and are slow in getting hard. U.S. Pat. No. 6,162,468 issued on Dec. 19, 2000 claims an invention that encompasses a frozen composition containing and active ingredient. The active ingredient include but not limited to nutrient mixture and a medicine. In it preferred embodiment, the chemical composition contains the following ingredients: a nutrient mixture, at least one flavoring agent, preservatives, food coloring and water balance. The composition can be placed in a sealed plastic bag and frozen for a nutrient enriched ice pop.

U.S. Pat. No. 7,033,629 discloses a process for producing a nutritious dessert comprising: a nutrient core of at least 1% by weight of the dessert product wherein the nutrient core includes at least one micronutrient selected from a group consisting of flote, magnesium, phosphorus, zinc, selenium, iron copper, chromium, molybdenum, manganese, iodine, potassium, sodium, vitamin A, vitamin C, vitamin D, vitamin B1, vitamin B2, vitamin B3, vitamin B5, vitamin B12, vitamin E, vitamin K, biotin, choline, chloride, vanadium, boron, and combinations thereof; and sweeteners inducing greater than 25% by weight of the total sugar of high freezing point depression sweeteners.

### BACKGROUND OF THE INVENTION

The art of making ice cream was introduced to the United States by colonist who brought their ice cream recipes with them. Confectioners, many of whom were Europeans sold ice cream at their shops in New York and many other cities during the era. Ice cream became popular throughout the world in the second half of the 20^{Th} century after cheap refrigeration became common. The art of making frozen pop has its origin in frozen desserts was started by the ancient Romans who carried blocks of ice down from the mountains in the summer months. The blocks were ground down into crushed ice that was flavored with fruit and syrup. Chocolate in all of its varied forms is probably America's most favorite convection. It has an annual per capita consumption of around 14 pounds per person. Presently chocolate is anbiquitous as a non essential food can be. The art of making freeze dried food came to be shortly after world war two. Its original development was a method of preserving blood plasma for battlefield emergencies without requiring refrigeration or damaging the organic nature of plasma during world war two. Coffee was the one of the first freeze dried products to be marketed on a large scale. Consumers for years have relished the taste of fast foods and soft drinks An example is “Coke Cola” which is the worlds largest selling beverage. And too, Mcdonald's “Big Mac” and Burger Kings' “Whopper” are the worlds largest selling Sandwiches. Non of these food items meet the nutritional values of an American Meal, yet Americans as well as the world love them and they are currently very reluctant to give them up.

American consumers trends are influencing new product. They want health and nutrition. They want natural and organic foods. The trend is toward wellness inside and outside. They want products that are enriched with vitamins and antioxidants. They want portion control meals and snacks.

Natural/organic foods are expected to grow 63% to more than $46 million by 2010 says Progressive Grocery, (May 24, 2006). Beginning in late 2006 Walmart started rolling out a complete selection of natural and organic foods in its nearly 4,000 stores wrote the New York Times, (Jun. 04, 2006).

The American consumers are starved for personal time. 68% of married mothers and 75% of single mothers with children under 18 are employed. Both parents work in 63% of “married with kids” families. Women work a average of 7 hours a day, while men work 8 hours average per day. One in five adults bring home work. Women spend a average of 3.5 hours a day doing house chores.

44% of all weekday meal preparation require about 30 minutes. 62% of American consumers are looking for eating trends that have ease of preparation. They want products that are pre-cooked, or easy to prepare, healthy, nutritional, natural, organic, easy to clean up, and taste great.

The busy lifestyles of the American consumer have changed traditional eating habits. The average American will miss almost 150 core meals per year by 2010. On the average the American consumer skipped 62 lunches in 2005. And that will increase to 65 lunches by 2010. The average American skipped 59 breakfasts in 2005. In 2010 that number will increase to 64 skipped breakfasts.

Americans are not eating enough healthy meals. The meals in question are defined by the USDA's Dietary Guidelines for Americans. It is imperative that something be done about it immediately. Americans are “junk food junkies”. And because of it America has become a nation of overweight and obese people. In the United States obesity has risen at an epidemic rate during the past 20 years. The latest results from the 1999-2006 National Health Nutrition Examination survey (NHANS) using measured heights and weights, indicate that a estimated 67% of American adults 20 years and older are either overweight or obese. This equates to over 129,000,000 Americans. The increase is not limited to adults. The percentage of young people who are over weight has more than tripled since 1980. Among children and teenaged Americans aged 6-19 years old, 17% are considered overweight. This equates to over 9,500,000 young people as overweight. All of the current data indicates that the situation is worsening rather than improving. The dieting programs are not enough. Americans need a change in their approach to food intake. Overweight and obesity are winning the war. Complication of the obesity epidemic include high cholesterol, high blood pressure, type 2 diabetes, mellitus, coronary plaque formation, and serious psychosocial implications.

Obesity is dramatically increasing not only in American children and adults, but also in every country in the world that has adopted similar cultural habits. The World Health Organization now considers obesity to be a global epidemic and a public health problem as more countries become westernized.

Approximately 300,000 deaths each year in the United States may be attributable to obesity. Overweight and obesity and their associated health problems have a significant economic impact on the U.S. health care system. According to a study, national health cost attributed to both overweight and obesity, medical expenses accounted for 9.6% of the U.S. medical expenditures in 1998 and may have reached as high as $78.5 billion, $92.6 billion in 2002. The latest study (January 2006) by the Pediatrics Committee on School Health has this number a $120 billion. Approximately half of the cost were paid by medicate and Medicare. Medicare has now officially declared obesity to be a disease, opening the floodgates for obesity treatment to be covered by Federal and private health insures. It is now forecasted that the health cost associated with obesity will almost double by the year end 2007, to $200 billion.

There is a definite and immediate need in the food market for the present invention as it employees an additional method of preparing a nutritional meal. The present invention meets all requirements for food intakes that are outlined in the National School Lunch Program. The present invention fits perfectly in the fast food market. Their needs to be a new platform of meals that meet the USDA and DASH food intake requirements. It is the objective of present invention to provide a tasteful and flavorful platform of meals that fills the gap in the nutritional food market. It is also the objective of the present invention to help improve the long turn health requirements of all individuals thus reducing medical cost as it relates to food intake.

### SUMMARY OF THE INVENTION

Briefly described, the present invention comprises a process for making, or preparing, various platforms of shelf stable, tasteful and flavored American meals that meets all the National School Lunch Program requirements, of food in take. Said requirements are further defined by the USDA and DASH publication Dietary Guidelines for Americans. Simply put Americans will be overwhelmed to get a meal that combines proven great taste with a balanced nutritional profile in all of the various defined meal platforms of the present invention. They will be different and unique in their way of packaging a complete meal. The idea of a baked meal, a ice cream meal, a popsicle meal, a freeze dried meal, a chocolate meal, a caramel meal, and a cereal meal will change the way Americans approach food intake. More important are the health issues that the new meals addresses. The overwhelming truth is, the prior art or present method(s) is failing and failing drastically with no end in sight. To summarize, Americans love to eat. Americans love to eat foods that taste great. The new platform of meals have both components, therefore they fit into the field of things Americans love to do.

Meal Structure for Lunch:

In the National School Lunch Program, meals are required to have three meal items for lunch. There are three categories.
1. Entrée, one serving; a combination of food or single food item offered as the main course;
2. Milk, one serving; fluid as a beverage must be offered, but no specific amount is required. Milk can be flavored or unflavored.
3. Side dish, one or more servings; any other meal item offered is considered a side dish unless it is a condiment.
4. Offer versus serve; at least three meal items must be offered. A entrée, a fluid milk, and a side dish. A student must select at least two of the three. One of the two must be an entrée. If there are more than three items of the meal unit, students may decline on more than two items of the meal items. The student can never decline the entrée.

Meal Structure for Breakfast:

National School breakfast Program, meals are required to have two meal items for breakfast. There are two categories;
1. Milk, one serving; fluid as a beverage, must be offered but no specific amount is required. Milk can be flavored or unflavored.
2. Side dish, one or more serving; any other item offered is considered a side dish unless it is a condiment.
3. Offer versus serve; student may decline a maximum of one meal item out of the two or more items offered.

### EXAMPLE #1

Coke Cola Cherry Baked Meal.

In accordance with the preferred embodiments of the present invention, the following food stuff ingredients, by measurement/weight, were combined and mixed together at room temperature using a Hamilton Beach model #58754 blender to form a liquid and then baked using to make a beverage meal that meets all the requirements of the National School Lunch Program.
1. Milk group; 1 cup of yogurt (Great Value's cherry low fat yogurt w/other natural flavors).
2. Vegetable group; 0.83333 cup of mixed vegetables (Flav-R-Pac's frozen mixed vegetable package).
3. Grain group; 2 slices of bread (Great Value's whole wheat bread).
4. Meat and beans group; 1.8333 pasteurized egg (sunny meadows')
5. Fruit group; 0.6666 cup cherry tidbits (Del Monte's canned cherry tidbits) and one banana.
6. Oil group; 2 tablespoon of low-fat mayonnaise.
7. Discretionary calorie allowance group; 1 package of splenda zero calorie sugar.
8. Flavor or taste group; 12 oz of Coca Cola Cherry, soft drink (Coca Cola Company)
9. Above food groups are mixed to liquid form, liquid per said claim 19.
10. 2.5 cup of Self rising flour(Great Value/Walmart).
11. 0.50 cup of all purpose flour(Great Value/Walmart).
12. 10 packs of Splenda zero calorie sugar.
13. 1.0 teaspoon of baking powder(Great Value/Walmart).
14. 2.0 teaspoon low calorie salt(Morten brand).
15. 0.25 cup melted low carb butter(Great Value/Walmart).
16. Pre-heat oven to 160 degree centigrade.
17. Lightly grease baking container with release agent (Pam spray).
18. In a bowl mix ingredient items 10 thru 15 with mixed group of item 9 to form dough of said claim
19. Pour into greased container and place in pre-heated oven.
19. Bake in oven until a toothpick or similar device inserted in the center comes out clean.
20. Remove from oven and allow to cool at least 5 minute. Baked goods are determined safe for human consumption.

### EXAMPLE #2

The Cherry Cola Cereal Meal.

In accordance with the preferred embodiments of the present invention, the following meal ingredients, by measurement/weight, were combined and mixed together at room temperature using a Hamilton Beach blender #58754 blender to form a liquid and then processed to make a cereal meal that meets all requirements of the National School Lunch Program.
1. Milk group; 1.5 cup low fat cherry yogurt (Great Value/Walmart).
2. Vegetable group; 0.83333 cup of mixed vegetables (Flav-R-Pac's canned mixed vegetables).
3. Grain group; 1 cups ready-to-eat cereal (Malt-O-Meal Company's crispy rice).
4. Meat and beans group; 0.7500 pasteurized egg
5. Fruit group; 1.5 cup fruit cut cherry tidbits.
6. Oil group; 1 tablespoon of low fat mayonnaise.
7. Discretionary calorie group; 4 packs of zero calorie Splenda sugar.
8. Flavor and taste group; 12 oz Cherry Coke.
9. Above food groups are mixed to form liquid, per said claim 20.
10. 2.5 cup of whole grain flour (Great Value/Walmart)
11. 0.5 cup of all purpose flour (Great Value/Walmart)
12. 4 packages of splenda zero calorie sugar
13. 0.2 teaspoon of baking powder (Great Value/Walmart)
14. 1.0 teaspoon low calorie salt (Morten Salt)
15. 0.2 cup melted low carb butter(GreatValue/Walmat)
16. Mix ingredients items 10 thru 15 in container with mixed group of item 9. Load batch into a rotating steam heated pressure cooker. Cook batch to moisture content of about 30% to 40%. The batch discharge is taken to a machine or working station where the large lumps of the cook ingredient swollen grain backs are broken apart into individuals grits.
17. The individual grits with to much moisture for flaking are dried under controlled heat and humidity to a level of about 10% to 17%. The dried grits are tempered, held for about 3 to 9 hours.
18. The tempered grits are ready for flaking. The grits are rolled and flatten to a thinness of about 0.024 to 0.010 inches. The flatten flakes are placed in a pre-heated oven of about 48 degree celcius minimum such that that finished flake have a moisture range of about 1.0% to 3.0%.
19. The finish flatten flakes are removed from the oven and allowed to cool at least 5 minutes, and sprayed with vitamins per claim 40, and placed in an air tight, water proof, plastic bag and consider safe for human consumption.

20. The finish puffed cereal uses same ingredients above items 1 thru 9. They are blended per claim 20 and processed per puffed meal said claim 40.

### EXAMPLE #3

The Cherry Coke Freeze Dried Meal

In accordance with the preferred embodiments of the present invention the following food stuff ingredients by measurement/weight, were combined and mixed together at room temperature using a Hamilton Beach model #58754 blender to for liquid and then made into a freeze dried meal that meets all the requirements of the National School Lunch Program.
1. Milk group; 1 cup of low fat cherry yogurt.
2. Vegetable group; 0.8333 cup of mixed vegetables.
3. Grain group; 2 slices of whole wheat bread.
4. Fruit group; 0.6666 cup of whole stem less cherries
5. Meat and beans group; 1 pasteurized egg.
6. Oil group; 2 tablespoons of low fat mayonnaise.
7. Discretionary calorie allowance group; 4 packs of zero calorie Splenda sugar.
8. Flavor or taste group; 12 ounce of Coca Cola Cherry.
9. All food stuff is mixed to form liquid per claim 4
10. Mixed foodstuff is made into non carbonate beverage per claim 35.
11. Mixed foodsuff meal made into freeze dried meal per said claim 42.

### EXAMPLE #4

Coke Cola Cherry Chocolate Mean.

In accordance with the preferred embodiments of the present invention the following food stuff ingredients by measurement/weight, were combined and mixed at room temperature using a Hamilton Beach blender model #58754 to form liquid and then made into a freeze dried meal.
1. Milk group; 1 cup of low fat cherry yogurt.
2. Vegetable group; 0.750 cup of mixed vegetables.
3. Grain group; 2 slices of whole wheat bread.
4. Meat and beans group; 0.5 cup of lima beans.
5. Fruit group; 3 cups of stem less cherries.
6. Oil group: 2 tablespoons of mayonnaise.
7. Discretionary calorie group; 20 packs of zero calorie Splenda sugar.
8. Flavor and taste group; 12 ounces of Coke Cola Cherry.
9. Above foodstuff is mixed to form slurry per claim 20.
10. slurry beverage made into chocolate meal per said claim 43.

### EXAMPLE #5

Coke Cola Cherry Caramel Meal.

In accordance with the preferred embodiments of the present invention, the following foodstuff ingredients, by weight/measurement, were combined and mixed together at room temperature using a Hamilton Beach model #58754 blender to form liquid and then made into a caramel meal.
1. Milk group; 2 cups of low fat cherry yogurt.
2. Vegetable group; 0.883 cup of mixed vegetables.
3. Grain group 1 cup of dried rice cereal.
4. Milk and beans group 2 pasteurized eggs.
5. Fruit group; 3 cup stem less cherries.
6. Oil group 2 tablespoons of low fat mayonnaise.
7. Discretionary calorie group 25 packs of zero calorie Splenda sugar.
8. Flavor and taste group; 12 ounce of Cherry Coke.
9. Above foodstuff mixed to slurry per said claim 20.
10. 175 packages of zero calorie sugar is boiled in water and mixed with blended above slurry and caramelized per said claim 44.

### EXAMPLE #6

Coke Cola Cherry Popsicle Meal.

In accordance with the preferred embodiments of the present invention, the following foodstuff ingredients, by measurement/weight, were combined and mixed together at room temperature using a Hamilton Beach model #58754 blender to form a liquid and then made into a popscile that meets all the requirements of the National School Lunch Program.
1. Milk group; 1 cup of low fat cherry yogurt.
2. Vegetable group; 0.833 cup of mixed vegetables.
3. Grain group; 1 cup of dried rice cereal.
4. Meat and beans group 0.50 cup lima beans.
5. Fruit group; 3 cups of fresh cherries.
6. Oil group; 2 tablespoon of low fat mayannaise.
7. Discretionary calorie group; 4 packs of zero calorie Splenda sugar.
8. Flavor and taste group; 12 ounce of Coke Cola Cherry.
9. Above food stuff mixed to form liquid per claim 20.
10. Mixed foodstuff made into carbonate beverage per said claim 35.
11. Carbonate beverage made into popsicle per claim 45.

### EXAMPLE #7

Coke Cola Cherry Ice Cream Antithesis Meal.

In accordance with the preferred embodiments of the present invention, the following foodstuff ingredients, by weight/measurement, were combined and mixed together at room temperature using a Hamilton Beach model #58754 blender to form a liquid and then made into an ice cream meal that meets the requirements of the National School Lunch program.
1. Milk group; 1 cup of low fat cherry yogurt.
2. Vegetable group; 0.8333 cup of mixed vegetables.
3. Grain group; 1 cup of dried rice cereal.
4. Meat and beans group; 1.833 pasteurized eggs.
5. Fruit group 3 cups of fresh cherries.
6. Oil group; 2 tablespoon of low fat mayonnaise.
7. Discretionary calorie group; none.
8. Flavor and taste group; 12 oz of Coke Cola Cherry.
9. Above foodstuff is mixed to form liquid per claim 20.
10. Mixed liquid foodstuff made in to non-carbonate beverage per said claim 35. Ingredients as follows:

| | | | | | | composition |
|---|---|---|---|---|---|---|
| | Weights | composition | composition | composition | composition | Total |
| Ingredients | (Per 100 kg) | Milk | MSNF | Sugar | Other | solids |
| Milk, | 52.1 | 1.8 | 4.5 | 0.0 | 0.0 | 6.3 |
| 3.4% | | | | | | |
| Cream, | 27.3 | 8.2 | 1.7 | 0.0 | 0.0 | 9.9 |
| 30% | | | | | | |
| Milk, | 3.9 | 0.0 | 3.8 | 0.0 | 0.0 | 3.8 |
| NFDM | | | | | | |
| Sugar, | 15.96 | 0.0 | 0.0 | 15.96 | 0.0 | 15.96 |
| splenda | | | | | | |
| Stabilizer/ | 0.4 | 0.0 | 0.0 | 0.0 | 0.4 | 0.4 |
| Emulsifier | | | | | | |
| Coke | 0.34 | 0.0 | 0.0 | 0.0 | 0.34 | 0.34 |
| cola | | | | | | |
| cherry | | | | | | |
| Totals | 100.0 | 10.0 | 10.0 | 16.0 | 0.6 | 36.5 |

11. Non carbonate beverage and ingredients used to make ice cream per said claim 47.

Whereas this invention has been described in detail with particular reference to its most preferred embodiments, it is understood that variations and modifications can be effected within the spirit and scope of the invention, as described herein before and as defined in the appended claims. The corresponding structures, materials, acts, and equivalents of all means plus function elements, if any, in the claims above are intended to include any structure, material, or acts for performing the functions in combination with other claimed elements as specifically claimed.

1. A process for preparing, making, flavoring and designing a slurry meal drink, a non carbonate meal drink, a carbonate meal drink, a baked meal, a cereal meal, a freeze dried meal, a chocolate meal, a caramel meal, a frozen rehydration meal, a ice cream antithesis meal wherein taking a commercial brand named product and adding food stuff, such that combined they meet the predetermined nutritional requirements based on age, sex, physical activity level, daily calories, daily nutrients, school age, school gender, school structure by grade, and specific dietary intake plans, of the national school lunch program, the dash eating plan and the united states department of agriculture's dietary guidelines for americans, as well as various other meal types as defined in present invention as well as a zero minimum calorie meal per above.

2. A process of claim 1, wherein a dietary intake menu plan for breakfast, lunch and, or supper, is present in the amount of a predetermined zero minimum calories per day requirements,with optional nutrients composition comprising:
(a) a requirement amount of 0.0001 grams minimum of protein, carbohydrate, monounsaturated fat, polyunsaturated fat, linoleic acid, alpha linolenic acid, total dietary fiber, potassium, sodium, chloride, carotenoids, arsenic, nickel, silicon, sulfate,and
(b) a requirement amount of 0.0001 milligrams minimum of vitamin C, vitamin E, thiamin, riboflavin, niacin, vitamin B6, pantothenic acid, chorine, calcium, fluoride, iron, magnesium, phosphorus, zinc, boron, vanadium,and
(c) a requirement amount of 0.0001 micrograms minimum of vitamin A, vitamin D, vitamin K, foliate, vitamin B12, biotin, chromium, copper, iodine, molybdenum, selenium, folic acid, and
(d) wherein total fat measured in grams not to exceed 30 percent of calories and, saturated fat to be less than 10 percent of calories.

3. A process of claim 1, wherein a dietary intake menu plan, traditional meal pattern, for lunch, breakfast, and, or supper to have required grades groups having school week averaged nutrient composition comprising:
(a) wherein for grade group pre school, a minimum calories of 517, protein of 7 grams minimum, calcium of 267 milligrams minimum, iron of 3.3 milligrams minimum, vitamin A of 150 RE minimum, vitamin C of 14 milligrams minimum, total fat not to exceed 30 percent of calories, and saturated fat to be less than 10 percent of calories, and
(b) wherein for grade group kindergarten through 3, a minimum calories of 633, protein of 9 grams minimum, calcium of 267 milligrams minimum, iron of 3.3 milligrams minimum, vitamin A of 200 RE minimum, vitamin C of 15 milligram minimum, total fat not to exceed 30 percent of calories, and saturated fat to be less than 10 percent of calories, and
(c) wherein for grade group 4 through 12, a minimum calories of 785, protein of 15 grams minimum, calcium of 370 milligrams minimum, iron of 4.2 milligrams minimum, vitamin A of 285 RE minimum, vitamin C of 17 milligrams minimum, total fat not to exceed 30 percent of calories, and saturated fat to be less than 10 percent of calories, and
(d) wherein for grade group 7 through 12 which is optional, a minimum calories of 825, protein of 16 grams minimum, calcium of 400 milligrams minimum, iron of 4.5 milligrams minimum, vitamin A of 300 RE minimum, vitamin C of 18 milligrams minimum, total fat not to exceed 30 percent of calories, and saturated fat to be less than 10 percent of calories.

4. A process of claim 1 wherein a dietary intake menu plan, enhanced meal pattern, for lunch, breakfast and, or supper to have required grade groups having school week averaged nutrients composition comprising:
(a) wherein for grades groups preschool, a minimum calories of 517, protein of 7 grams minimum, calcium of 267 milligrams minimum, iron of 3.3 milligrams minimum, vitamin A of 150 RE minimum, vitamin C of 14 milligrams minimum, total fat not to exceed 30 percent of calories, and saturated fat to be less than 10 percent of calories, and
(b) wherein for grades groups kindergarten through 6, a minimum calories of 664, protein of 10 grams minimum, calcium of 286 milligrams minimum, iron of 3.5 milligrams minimum, vitamin A of 224 RE minimum, vitamin C of 15 milligram minimum, total fat not to exceed 30 percent of calories, and saturated fat to be less than 10 percent of calories, and
(c) wherein for grades groups 7 through 12, a minimum calories of 825, protein of 16 grams minimum, calcium of 400 milligrams minimum, iron of 4.5 milligrams minimum, vitamin A of 300 RE minimum, vitamin C of 18 milligrams minimum, total fat not to exceed 30 percent of calories, and saturated fat to be less than 10 percent of calories, and
(d) wherein for grade groups kindergarten through 3, a minimum calories of 633, a protein of 9 grams minimum, calcium of 267 milligrams minimum, iron of 3.3 milligrams minimum, vitamin A of 200 RE minimum, vitamin C of 15 milligrams minimum, total fat not to exceed 30 percent of calories, and saturated fat to be less than 10 percent of calories.

5. A process of claim 1 wherein a dietary intake menu plan, traditional and enhanced meal patterns, for breakfast, lunch and, or supper to have required grade groups having school week averaged nutrients composition comprising:
(a) wherein for grade groups preschool, a minimum calories of 388, protein of 5 grams minimum, calcium of 200 milligrams minimum, iron of 2.5 milligrams minimum, vitamin A of 113 RE minimum, vitamin C of 11 milligrams minimum, total fat not to exceed 30 percent of calories, and saturated fat to be less than 10 percent of calories, and
(b) wherein for grades kindergarten through 12, a minimum calories of 554, protein of 10 grams minimum, calcium of 257 milligrams minimum, iron of 3.0 milligrams minimum, vitamin A of 197 RE minimum, vitamin C of 13 milligrams minimum, total fat not to exceed 30 percent of calories, and saturated fat to be less than 10 percent of calories, and
(c) wherein for grades 7 through 12 which or optional enhanced, a minimum calories of 618, protein of 12 gram minimum, calcium of 300 milligram minimum, iron of 3.4 milligrams minimum, vitamin A of 225 RE minimum, vitamin C of 14 milligrams minimum, total fat not to exceed 30 percent of calories, and saturated fat to be less than 10 percent of calories.

6. A process of claim 1, wherein a dietary intake menu plan, nutrient standard menu plan and assisted nutrient standard menu plan, for lunch, breakfast and, or supper to have established grade groups having school week averaged nutrient composition comprising:
(a) wherein for grade groups preschool, a minimum calories of 517, protein of 7 grams minimum, calcium of 267 milligrams minimum, iron of 3.3 grams minimum, vitamin A of 150 RE minimum, vitamin C of 14 milligram minimum, total fat not to exceed 30 percent of calories, and saturated fat to be less than 10 percent of calories, and
(b) wherein for grade group kindergarten through 6, a minimum calories of 664, protein of 10 grams minimum, calcium of 286 milligrams minimum, iron of 3.5 milligrams minimum, vitamin A of 224 RE minimum, vitamin C of 15 milligrams minimum, total fat not to exceed 30 percent of calories, and saturated fat to be less than 10 percent of calories, and
(c) wherein for grades 7 through 12, a minimum of 825 calories, protein of 16 grams minimum, calcium of 400 milligrams minimum, iron of 4.5 milligrams minimum, vitamin A of 300 RE minimum, vitamin C of 18 milligrams minimum, total fat not to exceed 30 percent of calories, and saturated fat to be less than 10 percent of calories, and
(d) wherein for grade group kindergarten through 3 which is optional, a minimum calories of 633, protein of 9 grams minimum, calcium of 267 milligrams minimum, iron of 3.3 milligrams minimum, vitamin A of 200 RE minimum, vitamin C of 15 milligrams minimum, total fat not to exceed 30 percent of calories, and saturated fat to be less than 10 percent of calories.

7. A process of claim 1, wherein a dietary intake plan, nutrient standard menu plan and assisted nutrient standard menu plan, for breakfast, lunch, and, or breakfast to have established grade groups having school week averaged nutrient composition comprising:
(a) wherein for grade group, preschool, a minimum calories of 388, protein of 5 grams minimum, calcium of 200 milligrams minimum, iron of 2.5 milligrams minimum, vitamin A of 113 RE minimum, vitamin C of 11 milligrams minimum, total fat not to exceed 30 percent of calories, and saturated fat to be less than 10 percent of calories, and
(b) wherein for grade group kindergarten through 12, a minimum calories of 554, protein of 10 grams minimum, calcium of 257 milligrams minimum, iron of 3.0 milligrams minimum, vitamin A of 197 RE minimum, vitamin C of 13 milligrams minimum, total fat not to exceed 30 percent of calories, and saturated fat to be less than 10 percent of calories, and
(c) wherein for grade group 7 through 12 which is optional, a minimum of 618 calories, protein of 12 grams minimum, calcium of 300 milligrams minimum, iron of 3.4 milligrams minimum, vitamin A of 225 RE minimum, vitamin C of 14 milligrams minimum, total fat not to exceed 30 percent of calories, saturated fat to be less than 10 percent of calories.

8. A process of claim 1, wherein a dietary intake menu plan, nutrient standard menu plan and assisted nutrient standard menu plan, for lunch, breakfast and, or supper to have established age groups having school week averaged nutrient considered optional with composition comprising:
(a) wherein for age group 3 through 6, minimum calories of 558, RDA for protein of 7.3 grams minimum, RDA for calcium of 267 milligrams minimum, RDA for iron of 3.3 milligrams minimum, RDA for vitamin A of 158 RE minimum, RDA for vitamin C of 14.6 milligram minimum, total fat not to exceed 30 percent of calories, and saturated fat to be less than 10 percent of calories, and
(b) wherein for age group 7 through 10, minimum calories of 667, RDA for protein of 9.3 grams minimum, RDA for calcium of 267 milligrams minimum, RDA for iron of 3.3 milligrams minimum, RDA for vitamin A of 233 RE minimum, RDA for vitamin C of 15.0 milligrams minimum, total fat not to exceed 30 percent of calories, and saturated fat to be less than 10 percent of calories, and
(c) wherein for age group 11 through 13, minimum calories of 783, RDA for protein of 15.0 grams minimum, RDA for calcium of 400 milligrams minimum, RDA for iron of 4.5 milligrams minimum, RDA for vitamin A of 300 RE minimum, vitamin C of 16.7 milligrams minimum, total fat not to exceed 30 percent of calories, and saturated fat to be less than 10 percent of calories, and
(d) wherein for age group 14 and older, minimum calories of 846, RDA for protein of 16.7 grams minimum, RDA for calcium of 400 milligrams minimum, RDA for iron of 4.5 milligram minimum, RDA for vitamin A of 300 RE minimum, RDA for vitamin C of 19.2 milligrams minimum, total at not to exceed 30 percent of calories, saturated fat to be less than 10 percent of calories.

9. A process of claim 1, wherein a dietary intake menu plan, nutrient standard menu plan and assisted nutrient standard menu plan, for breakfast, lunch, breakfast, and, or supper to have established age groups having school week averaged nutrient considered optional with a composition composing:
(a) wherein for age group 3 through 6, minimum calories of 419, RDA for protein of 5.5 grams minimum, RDA for calcium of 200 milligrams minimum, RDA for iron of 2.5 milligrams minimum, RDA for vitamin A of 119 RE minimum, RDA for vitamin C of 11.0 milligram minimum total fat not to exceed 30 percent of calories and saturated fat to be less than 10 percent of calories, and
(b) wherein for age group 7 through 10, minimum calorie of 500, RDA for protein of 7.0 grams minimum, RDA of calcium of 200 grams minimum, RDA for iron of 2.5 milligram, RDA or calcium for vitamin A of 175 RE minimum, RDA for vitamin C of 11.5 milligrams minimum, total fat not to exceed 30 percent of calories and saturated fat to be less than 10 percent of calories, and
(c) wherein for age group 11 through 13, minimum calories of 588, RDA for protein of 11.25 grams minimum, RDA for calcium of 300 milligrams minimum, RDA for iron of 3.4 milligrams minimum, RDA for vitamin A of 225 RE minimum, RDA for vitamin C of 12.5 milligrams minimum, total fat not to exceed 30 percent of calories and saturated fat to be less than 10 percent of calories, and
(d) wherein for age group 14 and older, minimum calories of 625, RDA for protein of 12.5 grams minimum, RDA for calcium of 300 milligrams minimum, RDA for iron of 3.4 milligrams minimum, RDA for vitamin A of 225 RE minimum, RDA for vitamin C of 14.4 milligrams minimum, total fat not to exceed 30 percent of calories, and saturated fat to be less than 10 percent of calories.

10. A process of claim 1, wherein a dietary intake menu plan, nutrient standard menu plan and assisted nutrient standard menu plan for lunch, supper, and, or breakfast to have customized age groups having school week averaged nutrient considered optional with composition comprising:
(a) wherein the menu planner can create a customized age grouping and nutrient standards that match the grade structure of the school such that the menu planner must use more than one group for a k-12 building, so the planner would simply not customize for the grade grouping to fit the school, and
(b) wherein the menu planner can customize a menu nutrient standard plan for ages 3 thru 5 for grades pre kindergarten to kindergarten, ages 6 thru 11 for grades 1 to 6, ages 12 thru 14 for grades 7 to 9, and ages 15 thru 17 for grades 10 to 12.

11. The process of claim 1, wherein a daily dietary intake menu plan for breakfast, lunch and, or supper having a plus or minus of 35% nutrient and a plus or minus of 200 calorie, and plus or minus of 35% of nutrients composition comprising:
(a) wherein for age group 1 thru 3 having calorie of 1000, vitamin A of 300 microgram, vitamin E of 6 milligram, vitamin C of 15 milligram, thiamin of 0.5 milligram, riboflavin of 0.5 milligram, niacin of 6 milligram, vitamin B6 of 0.5 milligram, folate of 150 microgram, vitamin B12 of 0.9 microgram, calcium of 500 milligram, phosphorus of 460 milligram, magnesium of 80 milligram, iron of 7 milligram, zinc of 3 milligram, copper of 340 microgram, sodium of less than 1500 milligram, potassium of 3000 milligram, protein of 13 gram, carbohydrate 130 gram, added sugar of less than 25%, total fiber of 14 grams, total fat of 30 to 40% of calories, saturated fat of less than 10% of calories, cholesterol of less than 300 milligram, linoleic acid of 7 gram, linolenic of 0.7 gram, and
(b) wherein for female age group 4 thru 8 having calorie of 1200, vitamin A of 400 microgram, vitamin E of 7 milligram, vitamin C of 25 milligram, thiamin of 0.6 milligram, riboflavin of 0.6 milligram, niacin of 8 milligram, vitamin B6 of 0.6 milligram, folate of 200 microgram, vitamin B12 of 1.2 microgram, calcium of 800 milligram, phosphorus of 500 milligram, magnesium of 130 milligram, iron of 7 milligram, zinc of 3 milligram, copper of 340 microgram, sodium of less than 1500 milligram, potassium of 3000 milligram, protein of 13 gram, carbohydrate 130 gram, added sugar of less than 25%, total fiber of 14 grams, total fat of 30 to 40% of calories, saturated fat of less than 10% of calories, cholesterol of less than 300, lioleic acid of 10 gram, linolenic acid of 0.9 gram, and
(c) wherein for male age group 4 thru 8 having calorie of 1400, vitamin A of 400 microgram, vitamin E of 7 milligram, vitamin C of 25 milligram, thiamin of 0.6 milligram, riboflavin of 0.6 milligram, niacin of 8 milligram, vitamin B6 of 0.6 milligram, folate of 200 microgram, vitamin B12 of 1.2 microgram, calcium of 800 milligram, phosphorus of 500 milligram, magnesium of 130 milligram, iron of 10 milligram, zinc of 5 milligram, copper of 440 microgram, sodium of less than 1900 milligram, potassium of 3800 milligram, protein of 19 gram, carbohydrate 130 gram, added sugar of less than 25%, total fiber of 20 grams, total fat of 25 to 35% of calories, saturated fat of less than 10% of calories, cholesterol of less than 300 milligram, linoleic acid of 10 gram, linolenic of 0.9 gram, and
(d) wherein for female age group 9 thru 13 having calorie of 1600, vitamin A of 600 microgram, vitamin E of 11 milligram, vitamin C of 45 milligram, thiamin of 0.9 milligram, riboflavin of 0.9 milligram, niacin of 12 milligram, vitamin B6 of 1.0 milligram, folate of 300 microgram, vitamin B12 of 1.0 microgram, calcium of 1300 milligram, phosphorus of 1250 milligram, magnesium of 240 milligram, iron of 8 milligram, zinc of 8 milligram, copper of 700 microgram, sodium of less than 2200 milligram, potassium of 4500 milligram, protein of 34 gram, carbohydrate 130 gram, added sugar of less than 25%, total fiber of 22 grams, total fat of 25 to 35% of calories, saturated fat of less than 10% of calories, cholesterol of less than 300 milligram, linoleic acid of 10 gram, linolenic of 1.0 gram, and
(e) wherein for female age group 51 and older having calorie of 1600, vitamin A of 700 microgram, vitamin E of 15 milligram, vitamin C of 75 milligram, thiamin of 1.1 milligram, riboflavin of 1.1 milligram, niacin of 14 milligram, vitamin B6 of 1.5 milligram, folate of 400 microgram, vitamin B12 of 2.4 microgram, calcium of 1200 milligram, phosphorus of 700 milligram, magnesium of 320 milligram, iron of 8 milligram, zinc of 8 milligram, copper of 900 microgram, sodium of less than 2300 milligram, potassium of 4700 milligram, protein of 43 gram, carbohydrate 130 gram, added sugar of less than 25%, total fiber of 22 grams, total fat of 20 to 15% of calories, saturated fat of less than 10% of calories, cholesterol of less than 300 milligram, linoleic acid of 11 gram, linolenic of 1.1 gram, and
(f) wherein for male age group 9 thru 13 having calorie of 1800, vitamin A of 600 microgram, vitamin E of 11 milligram, vitamin C of 45 milligram, thiamin of 0.9 milligram, riboflavin of 0.9 milligram, niacin of 12 milligram, vitamin B6 of 1.0 milligram, folate of 300 microgram, vitamin B12 of 1.8 microgram, calcium of 1300 milligram, phosphorus of 1250 milligram, magnesium of 240 milligram, iron of 8 milligram, zinc of 8 milligram, copper of 700 microgram, sodium of less than 2200 milligram, potassium of 4500 milligram, protein of 34 gram, carbohydrate 130 gram, added sugar of less than 25%, total fiber of 25 grams, total fat of 25 to 35% of calories, saturated fat of less than 10% of calories, cholesterol of less than 300 milligram, linoleic acid of 12 gram, linolenic of 1.2 gram, and
(g) wherein for female age group 14 thru 18 having calorie of 1800, vitamin A of 700 microgram, vitamin E of 15 milligram, vitamin C of 65 milligram, thiamin of 1.0 milligram, riboflavin of 1.0 milligram, niacin of 14 milligram, vitamin B6 of 1.2 milligram, folate of 400 microgram, vitamin B12 of 2.4 microgram, calcium of 1300 milligram, phosphorus of 1250 milligram, magnesium of 360 milligram, iron of 15 milligram, zinc of 9 milligram, copper of 890 microgram, sodium of less than 2300 milligram, potassium of 4500 milligram, protein of 46 gram, carbohydrate 130 gram, added sugar of less than 25%, total fiber of 25 grams, total fat of 25 to 35% of calories, saturated fat of less than 10% of calories, cholesterol of less than 300 milligram, linoleic acid of 11 gram, linolenic of 1.1 gram, and
(h) wherein for female age group 31 thru 50 having calorie of 1800, vitamin A of 700 microgram, vitamin E of 15 milligram, vitamin C of 75 milligram, thiamin of 1.1 milligram, riboflavin of 1.1 milligram, niacin of 14 milligram, vitamin B6 of 1.3 milligram, folate of 400 microgram, vitamin B12 of 2.4 microgram, calcium of 1000 milligram, phosphorus of 700 milligram, magnesium of 320 milligram, iron of 18 milligram, zinc of 8 milligram, copper of 900 microgram, sodium of less than 2300 milligram, potassium of 4700 milligram, protein of 43 gram, carbohydrate 130 gram, added sugar of less than 25%, total fiber of 25 grams, total fat of 20 to 35 of calories, saturated fat of less than 10% of calories, cholesterol of less than 300 milligram, linoleic acid of 12 gram, linolenic of 1.1 gram, and
(i) wherein for male age group 51 and older having calorie of 2000, vitamin A of 900 microgram, vitamin E of 15 milligram, vitamin C of 90 milligram, thiamin of 1.2 milligram, riboflavin of 1.3 milligram, niacin of 16 milligram, vitamin B6 of 1.7 milligram, folate of 400 microgram, vitamin B12 of 2.4 microgram, calcium of 1200 milligram, phosphorus of 700 milligram, magnesium of 420 milligram, iron of 8 milligram, zinc of 11 milligram, copper of 900 microgram, sodium of less than 2300 milligram, potassium of 4700 milligram, protein of 56 gram, carbohydrate 130 gram, added sugar of less than 25%, total fiber of 28 grams, total fat of 20 to 25% of calories, saturated fat of less than 10% of calories, cholesterol of less than 300 milligram, linoleic acid of 14 gram, linolenic of 1.6 gram, and
(j) wherein for female age group 19 thru 30 having calorie of 2000, vitamin A of 700 microgram, vitamin E of 15 milligram, vitamin C of 75 milligram, thiamin of 1.1 milligram, riboflavin of 1.1 milligram, niacin of 14 milligram, vitamin B6 of 1.3 milligram, folate of 400 microgram, vitamin B12 of 2.4 microgram, calcium of 1000 milligram, phosphorus of 700 milligram, magnesium of 310 milligram, iron of 18 milligram, zinc of 8 milligram, copper of 900 microgram, sodium of less than 2300 milligram, potassium of 4700 milligram, protein of 46 gram, carbohydrate 130 gram, added sugar of less than 25%, total fiber of 28 grams, total fat of 20 to 25% of calories, saturated fat of less than 10% of calories, cholesterol of less than 300 milligram, linoleic acid of 12 gram, linolenic of 1.1 gram, and
(k) wherein for male age group 14 thru 18 having calorie of 2200, vitamin A of 900 microgram, vitamin E of 15 milligram, vitamin C of 75 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1300 milligram, phosphorus of 1250 milligram, magnesium of 410 milligram, iron of 11 milligram, zinc of 11 milligram, copper of 890 microgram, sodium of less than 2300 milligram, potassium of 4700 milligram, protein of 52 gram, carbohydrate 130 gram, added sugar of less than 25%, total fiber of 31 grams, total fat of 25 to 35% of calories, saturated fat of less than 10% of calories, cholesterol of less than 300 milligram, linoleic acid of 16 gram, linolenic of 1.6 gram, and
(l) wherein for male age group 31 thru 50 having calorie of 2200, vitamin A of 900 microgram, vitamin E of 15 milligram, vitamin C of 90 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1000 milligram, phosphorus of 700 milligram, magnesium of 420 milligram, iron of 8 milligram, zinc of 11 milligram, copper of 900 microgram, sodium of less than 2300 milligram, potassium of 4700 milligram, protein of 56 gram, carbohydrate 130 gram, added sugar of less than 25%, total fiber of 31 grams, total fat of 20 to 25% of calories, saturated fat of less than 10% of calories, cholesterol of less than 300 milligram, linoleic acid of 17 gram, linolenic of 1.6 gram, and
(m) wherein for male age group 19 thru 30 having calorie of 2400, vitamin A of 900 microgram, vitamin E of 15 milligram, vitamin C of 90 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1000 milligram, phosphorus of 700 milligram, magnesium of 400 milligram, iron of 8 milligram, zinc of 11 milligram, copper of 900 microgram, sodium of less than 2300 milligram, potassium of 4700 milligram, protein of 56 gram, carbohydrate 130 gram, added sugar of less than 25%, total fiber of 34 grams, total fat of 20 to 35% of calories, saturated fat of less than 10% of calories, cholesterol of less than 300 milligram, linoleic acid of 17 gram, linolenic of 1.6 gram, and
(n) wherein for male age group 19 thru 30 having calorie of 2600, vitamin A of 900 microgram, vitamin E of 15 milligram, vitamin C of 90 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1000 milligram, phosphorus of 700 milligram, magnesium of 400 milligram, iron of 8 milligram, zinc of 11 milligram, copper of 900 microgram, sodium of less than 2300 milligram, potassium of 4700 milligram, protein of 56 gram, carbohydrate 130 gram, added sugar of less than 25%, total fiber of 36 grams, total fat of 20 to 25% of calories, saturated fat of less than 10% of calories, cholesterol of less than 300 milligram, linoleic acid of 17 gram, linolenic of 1.6 gram, and
(o) wherein for male age group 14 thru 18 having calorie of 2800, vitamin A of 900 microgram, vitamin E of 15 milligram, vitamin C of 75 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1300 milligram, phosphorus of 1250 milligram, magnesium of 410 milligram, iron of 11 milligram, zinc of 11 milligram, copper of 890 microgram, sodium of less than 2300 milligram, potassium of 4700 milligram, protein of 52 gram, carbohydrate 130 gram, added sugar of less than 25%, total fiber of 39 grams, total fat of 25 to 35% of calories, saturated fat of less than 10% of calories, cholesterol of less than 300 milligram, linoleic acid of 16 gram, linolenic of 1.6 gram, and
(p) wherein for male age group 19 thru 30 having calorie of 3000, vitamin A of 900 microgram, vitamin E of 15 milligram, vitamin C of 90 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1000 milligram, phosphorus of 700 milligram, magnesium of 400 milligram, iron of 8 milligram, zinc of 11 milligram, copper of 900 microgram, sodium of less than 2300 milligram, potassium of 4700 milligram, protein of 56 gram, carbohydrate 130 gram, added sugar of less than 25%, total fiber of 14 grams, total fat of 20 to 35% of calories, saturated fat of less than 10% of calories, cholesterol of less than 300 milligram, linoleic acid of 17 gram, linolenic of 1.6 gram, and
(q) wherein for male age group 14 thru 18 having calorie of 3200, vitamin A of 900 microgram, vitamin E of 15 milligram, vitamin C of 75 milligram, thiamin of 1.2 milligram, riboflavin of 1.3 milligram, niacin of 16 milligram, vitamin B6 of 1.3 milligram, folate of 400 microgram, vitamin B12 of 2.4 microgram, calcium of 1300 milligram, phosphorus of 1250 milligram, magnesium of 410 milligram, iron of 11 milligram, zinc of 11 milligram, copper of 890 microgram, sodium of less than 2300 milligram, potassium of 4700 milligram, protein of 52 gram, carbohydrate 130 gram, added sugar of less than 25%, total fiber of 45 grams, total fat of 25 to 35% of calories, saturated fat of less than 10% of calories, cholesterol of less than 300 milligram, linoleic acid of 16 gram, linolenic of 1.6 gram, and
(r) wherein for age group 1 thru 3, having vitamin A of 300 microgram, vitamin C of 15 milligram, vitamin D of 5.0 microgram, vitamin E of 6 milligram, vitamin K of 30 microgram, thiamin of 0.5 milligram, riboflavin of 0.5 milligram, niacin of 6.0 milligram, vitamin B6 of 0.5 milligram, folate of 150 microgram, vitamin B12 of 0.9 microgram, pantothenic acid of 2.0 milligram, biotin of 8.0 microgram, choline of 200 milligram, calcium of 500 milligram, chromium of 11 microgram, copper of 340 microgram, fluoride of 0.7 milligram, iodine of 90 microgram, iron of 7 milligram, magnesium of 80 milligram, manganese of 1.2 milligram, molybdemnum of 17 microgram, phosphorus of 460 milligram, selenium of 20 microgram, zinc of 3.0 milligram, potassium of 3.0 gram, sodium of 1.0 gram, chloride of 1.5 gram, total water of 1.3 liter, carbohydrate of 130 grams, total fiber of 19 gram, linoleic of 7.0 grams, linolenic of 0.7 gram, protein of 13 gram, and
(s) wherein for age group 4 thru 8, having vitamin A of 400 microgram, vitamin C of 25 milligram, vitamin D of 5.0 microgram, vitamin E of 7.0 milligram, vitamin K of 55 microgram, thiamin of 0.6 milligram, riboflavin of 0.6 milligram, niacin of 8.0 milligram, vitamin B6 of 0.6 milligram, folate of 200 microgram, vitamin B12 of 1.2 microgram, pantothenic acid of 3.0 milligram, biotin of 12.0 microgram, choline of 250 milligram, calcium of 800 milligram, chromium of 15 microgram, copper of 440 microgram, fluoride of 1.0 milligram, iodine of 90 microgram, iron of 10 milligram, magnesium of 130 milligram, manganese of 1.5 milligram, molybdemnum of 22 microgram, phosphorus of 500 milligram, selenium of 30 microgram, zinc of 5.0 milligram, potassium of 3.8 gram, sodium of 1.2 gram, chloride of 1.9 gram, total water of 1.7 liter, carbohydrate of 130 grams, total fiber of 25 gram, linoleic of 10.0 grams, linolenic of 0.9 gram, protein of 19 gram, and
(t) wherein for male age group 9 thru 13, having vitamin A of 600 microgram, vitamin C of 45 milligram, vitamin D of 5.0 microgram, vitamin E of 11 milligram, vitamin K of 60 microgram, thiamin of 0.9 milligram, riboflavin of 0.9 milligram, niacin of 12.0 milligram, vitamin B6 of 1.0 milligram, folate of 300 microgram, vitamin B12 of 1.8 microgram, pantothenic acid of 4.0 milligram, biotin of 20.0 microgram, choline of 375 milligram, calcium of 800 milligram, chromium of 15 microgram, copper of 440 microgram, fluoride of 1.0 milligram, iodine of 90 microgram, iron of 10 milligram, magnesium of 130 milligram, manganese of 1.9 milligram, molybdemnum of 34 microgram, phosphorus of 1250 milligram, selenium of 40 microgram, zinc of 8.0 milligram, potassium of 4.5 gram, sodium of 1.5 gram, chloride of 2.3 gram, total water of 2.4 liter, carbohydrate of 130 grams, total fiber of 31 gram, linoleic of 12.0 grams, linolenic of 1.2 gram, protein of 13 gram, and
(u) wherein for male age group 14 thru 18, having vitamin A of 900 microgram, vitamin C of 75 milligram, vitamin D of 5.0 microgram, vitamin E of 15 milligram, vitamin K of 75 microgram, thiamin of 1.2 milligram, riboflavin of 1.3 milligram, niacin of 16 milligram, vitamin B6 of 1.3 milligram, folate of 400 microgram, vitamin B12 of 2.4 microgram, pantothenic acid of 5.0 milligram, biotin of 25.0 microgram, choline of 550 milligram, calcium of 1300 milligram, chromium of 35 microgram, copper of 890 microgram, fluoride of 3.0 milligram, iodine of 150 microgram, iron of 11 milligram, magnesium of 410 milligram, manganese of 2.2 milligram molybdemnum of 43 microgram, phosphorus of 1250 milligram, selenium of 55 microgram, zinc of 11.0 milligram, potassium of 4.7 gram, sodium of 1.5 gram, chloride of 2.3 gram, total water of 3.3 liter, carbohydrate of 130 grams, total fiber of 38 gram, linoleic of 16.0 grams, linolenic of 1.6 gram, protein of 52 gram, and
(v) wherein for male age group 19 thru 30, having vitamin A of 900 microgram, vitamin C of 90 milligram, vitamin D of 5.0 microgram, vitamin E of 15 milligram, vitamin K of 120 microgram, thiamin of 1.2 milligram, riboflavin of 1.3 milligram, niacin of 16.0 milligram, vitamin B6 of 1.3 milligram, folate of 400 microgram, vitamin B12 of 2.4 microgram, pantothenic acid of 5.0 milligram, biotin of 30.0 microgram, choline of 550 milligram, calcium of 1000 milligram, chromium of 35 microgram, copper of 900 microgram, fluoride of 4.0 milligram, iodine of 150 microgram, iron of 8.0 milligram, magnesium of 400 milligram, manganese of 2.3 milligram, molybdemnum of 45 microgram, phosphorus of 700 milligram, selenium of 55 microgram, zinc of 11.0 milligram, potassium of 4.7 gram, sodium of 1.5 gram, chloride of 2.3 gram, total water of 2.7 liter, carbohydrate of 130 grams, total fiber of 25 gram, linoleic of 12.0 grams, linolenic of 1.1 gram, protein of 46 gram, and
(w) wherein for male age group 31 thru 50, having vitamin A of 900 microgram, vitamin C of 90 milligram, vitamin D of 5.0 microgram, vitamin E of 15 milligram, vitamin K of 120 microgram, thiamin of 1.2 milligram, riboflavin of 1.3 milligram, niacin of 16.0 milligram, vitamin B6 of 1.3 milligram, folate of 400 microgram, vitamin B12 of 2.4 microgram, pantothenic acid of 5.0 milligram, biotin of 30.0 microgram, choline of 550 milligram, calcium of 1000 milligram, chromium of 35 microgram, copper of 900 microgram, fluoride of 4.0 milligram, iodine of 150 microgram, iron of 8 milligram, magnesium of 420 milligram, manganese of 2.3 milligram, molybdemnum of 45 microgram, phosphorus of 700 milligram, selenium of 55 microgram, zinc of 11.0 milligram, potassium of 4.7 gram, sodium of 1.5 gram, chloride of 2.3 gram, total water of 2.7 liter, carbohydrate of 130 grams, total fiber of 25 gram, linoleic of 12.0 grams, linolenic of 1.1 gram, protein of 46 gram, and
(x) wherein for male age group 51 thru 70, having vitamin A of 900 microgram, vitamin C of 90 milligram, vitamin D of 10.0 microgram, vitamin E of 15 milligram, vitamin K of 120 microgram, thiamin of 1.2 milligram, riboflavin of 1.3 milligram, niacin of 16.0 milligram, vitamin B6 of 1.7 milligram, folate of 400 microgram, vitamin B12 of 2.4 microgram, pantothenic acid of 5.0 milligram, biotin of 30.0 microgram, choline of 550 milligram, calcium of 1200 milligram, chromium of 30 microgram, copper of 900 microgram, fluoride of 4.0 milligram, iodine of 150 microgram, iron of 8.0 milligram, magnesium of 420 milligram, manganese of 2.3 milligram, molybdemnum of 45 microgram, phosphorus of 700 milligram, selenium of 55 microgram, zinc of 11.0 milligram, potassium of 4.7 gram, sodium of 1.3 gram, chloride of 2.0 gram, total water of 3.7 liter, carbohydrate of 130 grams, total fiber of 30 gram, linoleic of 14.0 grams, linolenic of 1.6 gram, protein of 56 gram, and
(y) wherein for male age group 71 and older, having vitamin A of 900 microgram, vitamin C of 90 milligram, vitamin D of 15.0 microgram, vitamin E of 15 milligram, vitamin K of 120 microgram, thiamin of 1.2 milligram, riboflavin of 1.3 milligram, niacin of 16.0 milligram, vitamin B6 of 1.7 milligram, folate of 400 microgram, vitamin B12 of 2.4 microgram, pantothenic acid of 5.0 milligram, biotin of 30.0 microgram, choline of 550 milligram, calcium of 1200 milligram, chromium of 30 microgram, copper of 900 microgram, fluoride of 4.0 milligram, iodine of 150 microgram, iron of 8.0 milligram, magnesium of 420 milligram, manganese of 2.3 milligram, molybdemnum of 45 microgram, phosphorus of 700 milligram, selenium of 55 microgram, zinc of 11.0 milligram, potassium of 4.7 gram, sodium of 1.2 gram, chloride of 1.8 gram, total water of 2.7 liter, carbohydrate of 130 grams, total fiber of 21 gram, linoleic of 11.0 grams, linolenic of 1.1 gram, protein of 46 gram, and
(z) wherein for female age group 9 thru 13, having vitamin A of 600 microgram, vitamin C of 45 milligram, vitamin D of 5.0 microgram, vitamin E of 11 milligram, vitamin K of 60 microgram, thiamin of 0.9 milligram, riboflavin of 0.9 milligram, niacin of 12.0 milligram, vitamin B6 of 1.0 milligram, folate of 300 microgram, vitamin B12 of 1.8 microgram, pantothenic acid of 4.0 milligram, biotin of 20.0 microgram, choline of 375 milligram, calcium of 700 milligram, chromium of 21 microgram, copper of 700 microgram, fluoride of 2.0 milligram, iodine of 120 microgram, iron of 8 milligram, magnesium of 240 milligram, manganese of 1.6 milligram molybdemnum of 34 microgram, phosphorus of 1250 milligram, selenium of 40 microgram, zinc of 8.0 milligram, potassium of 4.5 gram, sodium of 1.5 gram, chloride of 2.3 gram, total water of 2.1 liter, carbohydrate of 130 grams, total fiber of 26 gram, linoleic of 10.0 grams, linolenic of 1.0 gram, protein of 34 gram, and
(aa) wherein for female age group 14 thru 18, having vitamin A of 700 microgram, vitamin C of 65 milligram, vitamin D of 5.0 microgram, vitamin E of 15.0 milligram, vitamin K of 75 microgram, thiamin of 1.0 milligram, riboflavin of 1.0 milligram, niacin of 14 milligram, vitamin B6 of 1.2 milligram, folate of 400 microgram, vitamin B12 of 2.4 microgram, pantothenic acid of 5.0 milligram, biotin of 25.0 microgram, choline of 400 milligram, calcium of 1300 milligram, chromium of 24 microgram, copper of 890 microgram, fluoride of 3.0 milligram, iodine of 150 microgram, iron of 15.0 milligram, magnesium of 360 milligram, manganese of 1.6 milligram, molybdemnum of 43 microgram, phosphorus of 1250 milligram, selenium of 55 microgram, zinc of 9.0 milligram, potassium of 4.7 gram, sodium of 1.5 gram, chloride of 2.3 gram, total water of 2.3 liter, carbohydrate of 130 grams, total fiber of 26 gram, linoleic of 11.0 grams, linolenic of 1.1 gram, protein of 46 gram, and
(bb) wherein for female age group 19 thru 30, having vitamin A of 700 microgram, vitamin C of 75 milligram, vitamin D of 5.0 microgram, vitamin E of 15.0 milligram, vitamin K of 90 microgram, thiamin of 1.1 milligram, riboflavin of 1.1 milligram, niacin of 14.0 milligram, vitamin B6 of 1.3 milligram, folate of 400 microgram, vitamin B12 of 1.3 microgram, pantothenic acid of 5.0 milligram, biotin of 30.0 microgram, choline of 425 milligram, calcium of 1000 milligram, chromium of 25.0 microgram, copper of 900 microgram, fluoride of 3.0 milligram, iodine of 150 microgram, iron of 18.0 milligram, magnesium of 310 milligram, manganese of 1.8 milligram, molybdemnum of 45 microgram, phosphorus of 700 milligram, selenium of 55 microgram, zinc of 8.0 milligram, potassium of 4.7 gram, sodium of 1.5 gram, chloride of 2.3 gram, total water of 2.7 liter, carbohydrate of 130 grams, total fiber of 25 gram, linoleic of 12.0 grams, linolenic of 1.1 gram, protein of 46 gram, and
(cc) wherein for age female group 31 thru 50, having vitamin A of 700 microgram, vitamin C of 75 milligram, vitamin D of 5.0 microgram, vitamin E of 15 milligram, vitamin K of 90 microgram, thiamin of 1.1 milligram, riboflavin of 1.1 milligram, niacin of 14.0 milligram, vitamin B6 of 1.3 milligram, folate of 400 microgram, vitamin B12 of 2.4 microgram, pantothenic acid of 5.0 milligram, biotin of 30.0 microgram, choline of 425 milligram, calcium of 1000 milligram, chromium of 25.0 microgram, copper of 900 microgram, fluoride of 3.0 milligram, iodine of 150 microgram, iron of 18.0 milligram, magnesium of 320 milligram, manganese of 1.8 milligram, molybdemnum of 45 microgram, phosphorus of 700 milligram, selenium of 55 microgram, zinc of 8.0 milligram, potassium of 4.7 gram, sodium of 1.5 gram, chloride of 2.3 gram, total water of 2.7 liter, carbohydrate of 130 grams, total fiber of 25 gram, linoleic of 12.0 grams, linolenic of 1.1 gram, protein of 46 gram, and
(dd) wherein for female age group 51 thru 70, having vitamin A of 700 microgram, vitamin C of 75 milligram, vitamin D of 10.0 microgram, vitamin E of 15 milligram, vitamin K of 90 microgram, thiamin of 1.1 milligram, riboflavin of 1.1 milligram, niacin of 14.0 milligram, vitamin B6 of 1.5 milligram, folate of 400 microgram, vitamin B12 of 2.4 microgram, pantothenic acid of 5.0 milligram, biotin of 30.0 microgram, choline of 425 milligram, calcium of 1200 milligram, chromium of 20 microgram, copper of 900 microgram, fluoride of 3.0 milligram, iodine of 150 microgram, iron of 8.0 milligram, magnesium of 320 milligram, manganese of 1.8 milligram, molybdemnum of 45 microgram, phosphorus of 700 milligram, selenium of 55 microgram, zinc of 8.0 milligram, potassium of 4.7 gram, sodium of 1.3 gram, chloride of 2.0 gram, total water of 2.7 liter, carbohydrate of 130 grams, total fiber of 21 gram, linoleic of 11.0 grams, linolenic of 1.1 gram, protein of 46 gram, and
(ee) wherein for female age group 71 and older, having vitamin A of 700 microgram, vitamin C of 75 milligram, vitamin D of 15.0 microgram, vitamin E of 15.0 milligram, vitamin K of 90 microgram, thiamin of 1.1 milligram, riboflavin of 1.1 milligram, niacin of 14.0 milligram, vitamin B6 of 1.5 milligram, folate of 400 microgram, vitamin B12 of 2.4 microgram, pantothenic acid of 5.0 milligram, biotin of 30.0 microgram, choline of 425 milligram, calcium of 1200 milligram, chromium of 20 microgram, copper of 900 microgram, fluoride of 3.0 milligram, iodine of 150 microgram, iron of 8.0 milligram, magnesium of 320 milligram, maganese of 1.8 milligram, molybdemnum of 45 microgram, phosphorus of 700 milligram, selenium of 55 microgram, zinc of 8.0 milligram, potassium of 4.7 gram, sodium of 1.2 gram, chloride of 1.8 gram, total water of 2.7 liter, carbohydrate of 130 grams, total fiber of 21 gram, linoleic of 11.0 grams, linolenic of 1.1 gram, protein of 46 gram, and
(ff) wherein for female pregnancy age group 14 thru 18, having vitamin A of 750 microgram, vitamin C of 80 milligram, vitamin D of 5.0 microgram, vitamin E of 15 milligram, vitamin K of 75 microgram, thiamin of 1.4 milligram, riboflavin of 1.4 milligram, niacin of 18.0 milligram, vitamin B6 of 1.9 milligram, folate of 600 microgram, vitamin B12 of 2.6 microgram, pantothenic acid of 6.0 milligram, biotin of 30.0 microgram, choline of 450 milligram, calcium of 130 milligram, chromium of 29 microgram, copper of 1000 microgram, fluoride of 3.0 milligram, iodine of 220 microgram, iron of 27 milligram, magnesium of 400 milligram, maganese of 2.0 milligram, molybdemnum of 50 microgram, phosphorus of 1250 milligram, selenium of 60 microgram, zinc of 12.0 milligram, potassium of 4.7 gram, sodium of 1.5 gram, chloride of 2.3 gram, total water of 3.3 liter, carbohydrate of 175 grams, total fiber of 28 gram, linoleic of 13.0 grams, linolenic of 1.4 gram, protein of 71 gram, and
(gg) wherein for female pregnancy age group 19 thru 30, having vitamin A of 770 microgram, vitamin C of 85 milligram, vitamin D of 5.0 microgram, vitamin E of 15 milligram, vitamin K of 90 microgram, thiamin of 1.4 milligram, riboflavin of 1.5 milligram, niacin of 18.0 milligram, vitamin B6 of 1.9 milligram, folate of 600 microgram, vitamin B12 of 2.6 microgram, pantothenic acid of 6.0 milligram, biotin of 30.0 microgram, choline of 450 milligram, calcium of 1000 milligram, chromium of 30 microgram, copper of 1000 microgram, fluoride of 3.0 milligram, iodine of 220 microgram, iron of 27 milligram, magnesium of 350 milligram, manganese of 2.0 milligram, molybdemnum of 50 microgram, phosphorus of 700 milligram, selenium of 60 microgram, zinc of 11.0 milligram, potassium of 4.7 gram, sodium of 1.5 gram, chloride of 2.3 gram, total water of 3.0 liter, carbohydrate of 175 grams, total fiber of 28 gram, linoleic of 13.0 grams, linolenic of 1.4 gram, protein of 71 gram, and
(hh) wherein for female pregnancy age group 31 thru 50, having vitamin A of 770 microgram, vitamin C of 85 milligram, vitamin D of 5.0 microgram, vitamin E of 15 milligram, vitamin K of 90 microgram, thiamin of 1.4 milligram, riboflavin of 1.4 milligram, niacin of 18.0 milligram, vitamin B6 of 1.9 milligram, folate of 600 microgram, vitamin B12 of 2.6 microgram, pantothenic acid of 6.0 milligram, biotin of 30.0 microgram, choline of 450 milligram, calcium of 1000 milligram, chromium of 30.0 microgram, copper of 1000 microgram, fluoride of 3.0 milligram, iodine of 220 microgram, iron of 27 milligram, magnesium of 360 milligram, manganese of 2.0 milligram, molybdemnum of 50 microgram, phosphorus of 700 milligram, selenium of 60 microgram, zinc of 11.0 milligram, potassium of 4.7 gram, sodium of 1.5 gram, chloride of 2.3 gram, total water of 3.0 liter, carbohydrate of 175 grams, total fiber of 29 gram, linoleic of 13.0 grams, linolenic of 1.4 gram, protein of 71 gram, and
(ii) wherein for lactation age group 14 thru 18, having vitamin A of 1200 microgram, vitamin C of 115 milligram, vitamin D of 5.0 microgram, vitamin E of 19 milligram, vitamin K of 75 microgram, thiamin of 1.4 milligram, riboflavin of 1.6 milligram, niacin of 17.0 milligram, vitamin B6 of 2.0 milligram, folate of 500 microgram, vitamin B12 of 2.8 microgram, pantothenic acid of 7.0 milligram, biotin of 35.0 microgram, choline of 550 milligram, calcium of 1300 milligram, chromium of 44 microgram, copper of 1300 microgram, fluoride of 3.0 milligram, iodine of 290 microgram, iron of 10 milligram, magnesium of 360 milligram, manganese of 2.6 milligram, molybdemnum of 50 microgram, phosphorus of 1250 milligram, selenium of 70 microgram, zinc of 13.0 milligram, potassium of 5.1 gram, sodium of 1.5 gram, chloride of 2.3 gram, total water of 3.8 liter, carbohydrate of 210 grams, total fiber of 29 gram, linoleic of 13.0 grams, linolenic of 1.3 gram, protein of 71 gram, and
(ii) wherein for lactation age group 19 thru 30, having vitamin A of 1300 microgram, vitamin C of 120 milligram, vitamin D of 5.0 microgram, vitamin E of 19 milligram, vitamin K of 90 microgram, thiamin of 1.4 milligram, riboflavin of 1.6 milligram, niacin of 17.0 milligram, vitamin B6 of 2.0 milligram, folate of 500 microgram, vitamin B12 of 2.8 microgram, pantothenic acid of 7.0 milligram, biotin of 35.0 microgram, choline of 550 milligram, calcium of 1000 milligram, chromium of 45 microgram, copper of 1300 microgram, fluoride of 3.0 milligram, iodine of 290 microgram, iron of 9 milligram, magnesium of 310 milligram, manganese of 2.6 milligram, molybdemnum of 50 microgram, phosphorus of 700 milligram, selenium of 70 microgram, zinc of 12.0 milligram, potassium of 5.1 gram, sodium of 1.5 gram, chloride of 2.3 gram, total water of 3.8 liter, carbohydrate of 210 grams, total fiber of 29 gram, linoleic of 13.0 grams, linolenic of 1.3 gram, protein of 71 gram, and
(kk) wherein for lactation age group 31 thru 50, having vitamin A of 1300 microgram, vitamin C of 120 milligram, vitamin D of 5.0 microgram, vitamin E of 19 milligram, vitamin K of 90 microgram, thiamin of 1.4 milligram, riboflavin of 1.6 milligram, niacin of 17.0 milligram, vitamin B6 of 2.0 milligram, folate of 500 microgram, vitamin B12 of 2.8 microgram, pantothenic acid of 7.0 milligram, biotin of 35.0 microgram, choline of 550 milligram, calcium of 1000 milligram, chromium of 45 microgram, copper of 1300 microgram, fluoride of 3.0 milligram, iodine of 290 microgram, iron of 9 milligram, magnesium of 320 milligram, manganese of 2.6 milligram, molybdemnum of 50 microgram, phosphorus of 700 milligram, selenium of 70 microgram, zinc of 12.0 milligram, potassium of 5.1 gram, sodium of 1.5 gram, chloride of 2.3 gram, total water of 3.8 liter, carbohydrate of 201 grams, total fiber of 29 gram, linoleic of 13.0 grams, linolenic of 1.3 gram, protein of 71 gram.

12. A process of claim 1, wherein an activity level for said dietary intake menu plan is present with a composition comprising:
(a) wherein a sedentary life style that includes only the light physical activity associated with typical day to day life and or less than 30 minute a day of at least moderate physical activity in addition to daily activities, and
(b) wherein a moderately active lifestyle that includes physical activity equivalent to walking about 1.5 to 3 miles per day at 3 to 4 miles per hour in addition to the light activity associated with typical day to day life and or at least 30 minute to 60 minute a day of at least moderate physical activity in additional to daily activities, and
(c) wherein an active lifestyle that includes physical activity equivalent to walking more than 3 miles per day at 3 or 4 mile per hour, in addition to the light activity associated with typical day to day life and or 60 minute or more of at least moderate physical activity in additional to daily activities.

13. A process of claim 1, wherein a daily dietary intake menu meal plan, for breakfast, lunch, and, or supper is present in the estimated energy requirements of plus or minus 200 calories per day for age, and gender groups, at the three levels of physical activity of said claim 12 with composition comprising:
(a) wherein all children, age 2 to 3 years at sedentary level of said claim 11 requires 1000 calories per day with nutrients per said claim 2, and
(b) wherein all children, age 2 to 3 years at moderately active level of said claim 11 requires 1000 to 1400 calories per day with nutrients per said claim 2, and
(c) wherein all children, age 2 to 3 years at active level of said claim 11 requires 1000 to 1400 calories per day with nutrients per said claim 2, and
(d) wherein female ages 4 to 8 years, at sedentary level of said claim 11 requires 1200 calories per day with nutrients per said claim 2, and
(e) wherein female ages 4 to 8 years, at moderately active level of said claim 11 requires 1400 to 1600 calories per day with nutrients per said claim 2, and
(f) wherein female ages 4 to 8 years, at active level of said claim 11 requires 1000 to 1800 calories per day with nutrients per said claim 2, and
(g) wherein female ages 9 to 13 years, at sedentary level of said claim 11 requires 1600 calories per day with nutrients per said claim 2, and
(h) wherein female ages 9 to 13 years, at moderately active level of said claim 11 requires 1600 to 2000 calories per day with nutrients per said claim 2, and
(i) wherein female ages 9 to 13 years, at active level of said claim 11 requires 1800 to 2200 calories per day with nutrients per said claim 2, and
(j) wherein female ages 14 to 18 years, at sedentary level of said claim 11 requires 1800 calories per day with nutrients per said claim 2, and
(k) wherein female ages 14 to 18 years, at moderately active level of said claim 11 requires 2000 calories per day with nutrients per said claim 2, and
(l) wherein female ages 14 to 18 years, at active level of said claim 11 requires 2400 calories with nutrients per said claim 2, and
(m) wherein female ages 19 to 30 years, at sedentary level of said claim 11 require 2000 calories per day with nutrients per said claim 2, and
(n) wherein female ages 19 to 30 years, at moderately active level of said claim 11 requires 2000 to 2200 calories per day with nutrients per said claim 2, and
(o) wherein female ages 19 to 30 years, at active level of said claim 11 requires 2400 calories per day with nutrients per said claim 2, and
(p) wherein female ages 31 to 50 years, at sedentary level of said claim 11 requires 1800 calories per day with nutrients per said claim 2, and
(q) wherein female ages 31 to 50 years, at moderately active level of said claim 11 requires 2000 calories per day with nutrient per said claim 2, and
(r) wherein female ages 31 to 50 years, at active level of said claim 11 requires 2200 calorie per day with nutrients per said claim 2, and
(s) wherein female ages 51 years and older, at sedentary level of said claim 11 requires 1600 calories per day with nutrients per said claim 2, and
(t) wherein female ages 51 years and older, at moderately active level of said claim 11 requires 1800 calories per day with nutrients per said claim 2, and
(u) wherein female ages 51 years and older, at active level of said claim 11 requires 2000 to 2200 calories per day with nutrients per said claim 2, and
(v) wherein male ages 4 to 8 years, at sedentary level of said claim 11 requires 1400 calories per day with nutrients per aid claim 2, and
(w) wherein male ages 4 to 8 years, at moderately active level of said claim 11 requires 1400 to 1600 calories per day with nutrient per said claim 2, and
(x) wherein male ages 4 to 8 years, at active level of said claim 11 requires 1600 to 2000 calories per day with nutrients per said claim 2, and
(y) wherein male ages 9 to 13 years, at sedentary level of said claim 11 requires 1800 calories per day with nutrient per said claim 2, and
(z) wherein male ages 9 to 13 years, at moderately active level of said claim 11 requires 1800 to 2000 calories per day with nutrients per said claim 2, and
(aa) wherein male ages 9 to 13 years, at active level of said claim 11 requires 2000 to 2600 calories per day with nutrients per said claim 2, and
(bb) wherein male ages 14 to 18 years, at sedentary level of said claim 11 requires 2200 calories per day with nutrients per said claim 2, and
(cc) wherein male ages 14 to 18 years, at moderately active level of said claim 11 requires 2400 to 2800 calories per day with nutrients per said claim 2, and
(dd) wherein male ages 14 to 18 years, at active level of said claim 11 requires 2800 to 3200 calories per day with nutrients per said claim 2, and
(ee) wherein male ages 19 to 30 years, at sedentary level of said claim 11 requires 2400 calories per day with nutrients per said claim 2, and
(ff) wherein male ages 19 to 30 years, at moderately active level of said claim 11 requires 2600 to 2800 calories per day with nutrients per said claim 2, and
(gg) wherein male ages 19 to 30 years, at active level of said claim 11 requires 3000 calories per day with nutrients per said claim 2, and
(hh) wherein male ages 31 to 50 years, at sedentary level of said claim 11 requires 2200 calories per day with nutrients per said claim 2, and
(ii) wherein male ages 31 to 50 years, at moderately active level of said claim 11 require 2400 to 2600 calories per day with nutrient per said claim 2, and
(jj) wherein male ages 31 to 50 years, at active level of said claim 11 requires 2800 to 3000 calories per day with nutrients per said claim 2, and
(kk) wherein male ages 51 years and older, at sedentary level of said claim 11 requires 2000 calories per day with nutrients per said claim 2, and
(ll) wherein male ages 51 years and older, at moderately active level of said claim 11 requires 2200 to 2400 calories with nutrients per said claim 2, and
(mm) wherein male ages 51 years and older, at active level of said claim 11 requires 2400 to 2800 calories per day with nutrients per said claim 2, and
(nn) wherein all children ages 3 thru 5 for grades pre kindergarten to kindergarten at sedentary level of said claim 11, moderately active level of said claim 11 and or active level of said claim 11 requires 1000 to 1600 calories per day with nutrients per said claim 2, and
(oo) wherein all children ages 6 thru 11 for grades 1 to 6 at sedentary level of said claim 11, moderately active level of said claim 11, and or active level of said claim 11 requires 1200 to 2200 calories per day with nutrients per said claim 2, and
(pp) wherein all children ages 12 thru 14 for grades 7 to 9 at sedentary level of said claim 11, moderately active level of said claim 11 and or active level of said claim 11 requires 1600 to 2800 calories with nutrients per said claim 2, and
(qq) wherein all children ages 15 thur 17 for grades 10 thru 12 at sedentary level of said claim 11, moderately active level of said claim 11, and or active level of said claim 11 requires 1800 to 3200 calories per day with nutrients per said claim 2, and
(rr) wherein for all ages human beings requirement of 0 to 100,000 calories per day with nutrients per said claim 2.

14. A process of claim 1, wherein a dietary food intake plan of food groups composition comprising:
(a) wherein a milk group, consist of all fluid, dried, and, or dehydrated milk product and foods made from milk product that retain their calcium content and has a daily requirement of 0 to 50 cups, and about 1 cup equivalent composition comprising:
(1) 1 cup low fat or fat-free milk, yogurt, and
(2) 1½ ounces of low-fat or fat-free natural cheese, and
(3) 2 ounces of low fat or fat-free processed cheese, and
(b) wherein a vegetable group, consist of any vegetable or vegetable juice, weather raw or cooked, fresh, frozen, canned, dried, dehydrated, whole, cut-up and, or mashed and has a daily requirement of 0 to 50 cups with about ½ cup equivalent composition comprising:
(1) 1 cup raw leafy vegetables, and
(2) ½ cup of cut-up raw, or cooked, canned, frozen, vegetables, and
(3) ½ to ¾ cup vegetable juice, and
(c) wherein a grain group, consist of any food or food juice made from wheat, rice, oats, cornmeal, barely and, or other grain product, and any juices, oils, dried and, or dehydrated products made from any said grain product and has a daily requirement of 0 to 50 ounces with about 1 ounce equivalent composition comprising:
(1) 1 slice of bread, and
(2) ½ to ¼ cup or 1 ounce dry cereal, and
(3) ½ cup cooked rice, pasta, cereal, and
(4) 1/24 to ¾ cup of grain oil, and
(5) 2 to 20 ounces of grain juice, and
(d) wherein a meat and beans group consist of all food and, or juices, made from meat, poultry, fish, dry beans, peas, eggs, nuts, and seeds such that meats, poultry, fish to be cook cooked, dried, dehydrated, with beans and peas to be cooked, dried, dehydrated, canned and, or frozen, and eggs to be pasteurized, cooked, raw, dried, frozen, and, or dehydrated with a daily requirements of 0 to 50 ounces with, about 1 ounce equivalent composition comprising:
(1) 1 ounce of cooked, dried, dehydrated lean meats, poultry, fish, and
(2) ½ cup canned, frozen, dried, dehydrated, cooked dry beans, tofu, peas, and
(3) 1 egg, raw, pasteurized, frozen, dried, Dehydrated, and
(4) 1 tablespoons peanut butter, and
(5) ½ to 1½ ounce nuts or seeds, and
(6) ½ to ¾ cup of meat and bean juice, and
(e) wherein a fruit group, consist of any fruit or fruit juice, fresh, canned, dehydrated, frozen or dried, whole cup-up or pureed with a daily amount requirement of 0 to 50 cups with, about ½ cup equivalent composition comprising:
(1) 1 medium fruit, and
(2) ½ cup fresh, frozen, or canned fruit, and
(3) ¼ cup dried fruit, and
(4) ½ to ¾ cup fruit juice, and
(f) wherein a oil group, consist of canola, corn, cottonseed, olive, soybean, sunflower, fish, nut, avocados oils, such that they are liquid at room temperature and, or frozen, dried, and dehydrated with a daily requirement of 0 to 50 grams with, about 1 teaspoon equivalent composition comprising:
(1) 1 tablespoon low fat mayonnaise, and
(2) 2 tablespoons of light salad dressing, and
(3) 1 teaspoon vegetable oil, and
(4) 1 teaspoon soft margarine, and
(g) wherein a discretionary calorie allowance group, with a daily requirement of 0 to 567 calories, and or 0 to 50 tablespoon of sugar per week with, about 1 tablespoon sugar equivalent composition comprising:
(1) ½ ounce jelly beans, and
(2) 8 ounces lemonade, and
(3) 1 table spoon jelly and, or jam.

15. A process of claim 1, wherein a flavor, a commercial brand named product and, or generic tasting brand named product, and, or new taste formulation taste group, dietary intake menu plan including but not limited to a composition comprising:
(a) wherein a soft drinks composition comprising:
(1) coca cola zero,
(2) diet dr pepper,
(3) mealade lime,
(4) diet pepsi, and
(b) wherein a sport drinks composition comprising:
(1) gatorade,
(2) powerade, and
(c) wherein a coffee composition comprising:
(1) maxwell house,
(2) flogers,
(3) sanka, and
(d) wherein a beer non-alcohol composition comprising:
(1) miller lite,
(2) bud light,
(3) coors light and,
(e) wherein a wine non alcohol composition comprising:
(1) spumante red,
(2) morgan david peach,
(3) boones farm apple,
(4) ripple green apple, and
(f) wherein a hard liquor non alcohol composition comprising:
(1) jim daniels black label,
(2) seagram vodka,
(3) chavis regal scotch,
(4) jim beam whisky, and
(g) wherein a ice creams composition comprising:
(1) belmont lemon,
(2) blue belle strawberry,
(3) carvel kiwi, and
(h) wherein interstate brands cooperation of kansas city, missouri menu composition comprising:
(1) hostess twinkies,
(2) hostess hohos,
(3) hostess ding dongs,
(4) hostess mini muffins,
(5) hostness cupcakes,
(6) hostness suzy q's,
(7) hostness donettes,
(8) hostness fruit pie, and
(i) wherein burger king cooperation of miami, florida menu composition comprising:
(1) cheeseburger,
(2) hamburger,
(3) chicken tenders sandwich,
(4) french fries,
(5) bacon double cheeseburger, and
(j) wherein mcdonald cooperation of oakbrook, llinois menu composition comprising:
(1) big mac,
(2) big and tasty,
(3) crispy chicken,
(4) file of fish,
(5) chicken mcgrill,
(6) french fries, and
(j) wherein a bouillon and, or pizza topping group including but not limited to composition comprising:
(1) beef,
(2) chicken,
(3) cheese,
(4) lamb, and
(5) pepperoni.

16. A process of claim 1, wherein a dietary intake menu plan of material that flour is made from including, but not limited to composition comprising:
(a) wheat, kamut, tritcate, rye, oat, barley, buckwheat, millet, amaranth, teff, rice, potato, soy, topioca, corn, quinoa, legume based, taro, nuts, peas, beans, and arrowroot.

17. A process of claim 1, wherein a dietary intake menu plan of said claim 16 is the labeling of flour types, including, but not limited to composition comprising:
(a) all purpose or plain flour, whole grain flour, germ flour, bleach flour, bromate flour, cake flour, graham flour, pastry or cookie flour, bread flour, self rising flour, durum flour, corn flour, rye flour, rice flour, chestnut flour, chickpea flour, teff flour, atta flour, tang flour, glutinous rice flour, peasmeal and, or pea flour, bean flour, soy flour, and almond flour.

18. A process of claim 1, wherein a dietary intake menu plan of leavening agents including, but not limited to composition comprising:
(a) baking powder, yeast, baking soda, potassium carbonate, potassium bicarbonate, potassium bitartrate, potassium carbonate, monocalcium, unpasteurized beer, buttermilk, ginger, kefir, sourdough starter, yogurt, bread improver, chef, poolish, desem, proofing or baking technique, and levain.

19. A process of claim 1, wherein a dietary intake menu plan of baking oils, including, but not limited to composition comprising:
(a) butter, gee clarified butter, canola oil, coconut oil, corn oil, cottonseed oil, grape seed oil, vegetable oil, hard margarine, soft margarine, extra virgin olive oil, virgin olive oil, refined olive oil, extra light olive oil, palm oil, peanut oil, safflower oil, soybean oil, and sunflower oil.

20. A process of claim 1, wherein a dietary intake menu plan of mixing foodstuff at a required speed and at substantially room temperature, for a period of time sufficient to form liquid, slurry, puree, batter, and or dough.

21. A process of claim 1, wherein a dietary intake menu plan of salt, including, but not limited to composition comprising:
(a) table salt, kosher salt, sea salt, french salt, hawaiian salt, black salt, bamboo salt, pickling salt, rock salt, course salt, fine salt, margarita salt, popcorn salt, and pretzel salt.

22. A process of claim 1, wherein having a dietary intake menu plan of sugar, including, but not limited to composition comprising:
(a) caster superfine sugar, cinnamon sugar, dark muscovado sugar, demerara sugar, european cut brown suger, european cut white sugar, fondant and icing sugar, golden bakers sugar, maple suger, turbinado sugar, vanilla sugar, sanding sugar, raw sugar, pearl sugar, splenda a zero calorie sugar, indulge a zero calorie sugar, fasweet liquid zero calorie sweetener, corn starch, corn syrup, sugar cane, and caramelized sugar.

23. A process of claim 1, wherein having a dietary intake menu design of additives, including but not limited to composition comprising:
(a) acids, acidity regulators, anticaking agents, antiforming agents, antistaling agents, bulking agents, food coloring, color retention agents, emulsifiers, flavours, flavour enhancers, flour enchancers, flour treatment agents, huectants, armoas, preservatives, bouillons, stabilzers, whey, sweeteners, yogurt, phosphoric acid, citric acid, benzoate, benzonic acid kappa-carageenan, nuts, fruits, candy, calcuim supplementation, vitiam supplementation, and thickeners.

24. A process of claim 1, having a dietary intake menu design of shelf stable methods including but not limited to composition comprising:
(a) U.S. Pat. No. 6,355,282, and U.S. Pat. No. 6,551,640, and U.S. Pat. No. 4,372,982, and U.S. Pat. No. 6,592,925, and U.S. Pat. No. 4,911,939, and U.S. Pat. No. 5,079,012, and U.S. Pat. No. 6,720,015, and U.S. Pat. No. 6,899,905, and U.S. Pat. No. 6,663,904, and U.S. Pat. No. 5,968,566, and U.S. Pat. No. 6,863,917, and U.S. Pat. No. 4,904,493.

25. A process of claim 1, wherein having a dietary intake, milk group meal, design composition comprising:
(a) at least one or a multiple of combination of options and, or their individual items of said additives of said claims 23 and menu plans, of said claims 2 thru 13, thereof is present in the amount to contribute to the whole of the meal design, and
(b) at least one option or a multiple combination of options of said milk group, of said claim 14 thereof is present in the amount to contribute to the whole of the meal design, and
(c) at least one option or a multiple of combination of options of said taste group, of said claim 15 thereof is present in the amount to contribute to the whole of a meal design, and
(d) wherein at least one or a multiple of combination of said options of this claim 25, are mixed to form liquid, slurry, or puree of said claim 20 and determined safe for human consumption.

26. A process of claim 1, wherein having a dietary intake, vegetable group meal, design composition comprising:
(a) at least one or a multiple of combination of options and, or their individual items of said additives, of said claim 23 and menu plans, of said claims 2 thru 13 thereof is present in the amount to contribute to the whole of the meal design, and
(b) at least one option or multiple of combination of options of said vegetable group, of said claim 14 thereof is present in the amount to contribute to the whole of the meal design, and
(c) at least one option or a multiple of combination of options of said taste group of said claim 15 thereof is present in the amount to contribute to the whole of the meal design, and
(d) wherein at least one or a multiple of combination of said options of this claim 26, are mixed to form liquid, slurry, or puree of said claim 20 and determined safe for human consumption.

27. A process of claim 1, wherein having a dietary intake, grain group meal, design composition comprising:
(a) at least one or a multiple of combinations of options and, or their individual items of said additives, of said claim 23 and menu plans of said claims 2 thru 13 thereof is present, in the amount to contribute to the whole of the meal design and,
(b) at least one option or a multiple of combination of options of said grain group of said claim 14, thereof is present in the amount to contribute to the whole of the meal design, and
(c) at least one option or a multiple of combination of options of said taste group of said claim 15 thereof is present in the amount to contribute to the whole of a meal design, and
(d) wherein at least one or a multiple of combination of said options of this claim 27, are mixed to form liquid, slurry or puree of said claim 20 and determined safe for human consumption.

28. A process of claim 1, wherein having a dietary intake, meat and beans group meal, design composition comprising:
(a) at least one or a multiple of combinations of options and, or their individual items of said additives, of said claim 23 and menu plan of said claims 2 thru 13, thereof is present in the amount to contribute to the whole of the meal design, and
(b) at least one option or a multiple of combinations of options of said meat and beans group, of said claim 14 thereof is present in the amount to contribute to the whole of the meal design, and
(c) at least one option or a multiple of combinations of options of said taste group of said claim 15 thereof is present in the amount to contribute to the whole of a meal design, and
(d) wherein at least one or a multiple of combination of options of this claim 28 are mixed to form slurry, or puree of said claim 20 and determined safe for human consumption.

29. A process of claim 1, wherein having a dietary intake, fruit group meal, design composition comprising:
(a) at least one or a multiple of combinations of options and, or their individual items of said additives, of said claim 23 and menu plans of said claims 2 thru 13, thereof is present in the amount to contribute to the whole of the meal design, and
(b) at least one option or a multiple of combinations of options of said fruit group, of said claim 14, thereof is present in the amount to contribute to the whole of the meal design, and
(c) at least one option or a multiple of combination of options of said taste group of said claim 15, thereof is present in the amount to contribute to the whole of a meal design, and
(d) wherein at least one or a multiple of combinations of said options of this claim 29, are mixed to form liquid, slurry, or puree of said claim 20 and determined safe for human consumption.

30. A process of claim 1, wherein a dietary intake, oil group meal, design composition comprising:
(a) at least one or a multiple of combinations of options and, or their individual items of said additives of said claims 22 and menu plans of said claims 2 thru 13, thereof is present in the amount to contribute to the whole of a meal design, and
(b) at least one option or a multiple of combination of options of said oil group, of said claim 14 thereof is present in the amount to contribute to the whole of the meal design, and
(c) at least one or a multiple of combination of options of said taste group of said claim 15 thereof is present in the amount to contribute to the whole of a meal design, and
(d) wherein at least one or a multiple of combination of said options of this claim 30, are mixed to form liquid slurry or puree of said claim 20 and determined safe for human consumption.

31. A process of claim 1, wherein a dietary intake, discretionary calorie group meal, design composition comprising:
(a) at least one or a multiple of combination of options and, or their individual items of said additives, of said claims 23 and menu plans of said claims 2 thru 13, thereof is present in the amount to contribute to the whole of the meal design, and
(b) at least one option or a multiple of combination of options of said discretionary calorie group allowance, of said claim 14 thereof is present in the amount to contribute to the whole of the meal design, and
(c) at least one or a multiple of combinations of options of said taste group of said claim 15 thereof is present in the amount to contribute to the whole of a meal design, and
(d) wherein at least one or a multiple of combinations of said options of this claim 31, are mixed to form liquid, slurry, or puree of said claim 20 and determined safe for human consumption.

32. A process of claim 1, wherein a dietary intake, flavor, commercial brand name taste group meal, design composition comprising:
(a) at least one or a multiple of combinations of options and, or their individual items of said additives of said claims 23, and menu plans of said claim 2 thru 13, thereof is present in the amount to contribute to the whole of the meal design, and
(b) at least one option or a multiple of combination of options of said flavor and taste group, of said claim 15, thereof is present in the amount to contribute to the whole of the meal design, and
(c) at least one option or a multiple of combinations of options of said food group, of said claim 14, thereof, is present in the amount to contribute to the whole of a meal design, and
(d) wherein at least one or a multiple of combination of said options of this claim 32, are mixed to form liquid, slurry, or puree of said claim 20 and determined safe for human consumption.

33. A process of claim 1, wherein a dietary intake, the mixed food groups meal, composition comprising:
(a) wherein at least one or a multiple of combinations of options of said menu plan of said claim 2 thru 13 thereof is present in the amount to contribute to the whole of the meal design, and
(b) wherein at least one or a multiple of combinations of options of said mixed food groups of said claims 25 thru 32 thereof is present in the amount to contribute to the whole of the meal design, and
(c) wherein at least one or a multiple of combinations of options of said additives, of said claim 23, which includes aromas, flavours, preservatives, and colorants, thereof is present in the amount to contribute to the whole of the meal design, and
(d) wherein at least one or a combination of items of said, flavor, commercial brand name product, taste group of said claim 15 thereof is present in the amount to contribute to the whole of the meal plan, and
(e) wherein at least one or a multiple of combination of said options of this claim 33, are mixed to form liquid, slurry, or puree of said claim 20 and determined safe for human consumption.

34. A process of claim 1, wherein methods of pasteurizing mixed Group meal composition comprising:
(a) high temperature short time pasteurization requires heating foodstuff to 72 centigrade degrees for 15 seconds, and
(b) ultra pasteurization requires heating foodstuff to a temperature of 89 degrees centigrade for 1.0 seconds, and
(c) ultra pasteurization requires heat food stuff to a temperature of 90 degrees centigrade for 0.5 seconds, and
(d) ultra pasteurization required heating food stuff to a temperature of 94 degrees centigrade for 0.05 seconds, and
(e) ultra pasteurization requires heating food stuff to temperature of 100 degrees centigrade for 0.01 seconds, and
(f) ultra high temperature sterilization requires heating food stuff to a temperature of 138 degrees centigrade for 2.0 seconds, and
(g) ultra high temperature sterilization requires heating food stuff to a temperature of 141 degree centigrade for 1.0 seconds.

35. A process of claim 1, wherein of carbonating a mixed food group meal of claim 33 to make a carbonate meal composition comprising:
(a) wherein said mixed food group meal of said claim 33 thereof is present at room temperature to contribute to the method of carbonation, and
(b) preheating mixed food group meal of said claim 33 within a temperature and time of at least 65 to 137 degree centigrade for a period not to exceed 15 seconds, and
(c) heating, pasteurizing mixed food group meal of said claim 33 wherein at temperature and time of said claim 34 at a pressure sufficient for killing and sterilizing, pathogens, microorganisms and bacteria such that ingredients and preservative ingredients are added sequentially and each ingredient is mixed before the next ingredient is added, and
(d) cooling the mixed food group meal of said claim 33 to a temperature of less than about 10 degrees centigrade, subjecting the cooled mixed food stuff to pressurized carbon dioxide from a carbonator at sufficient pressures and for sufficient time such that taste and mouth feel of carbonated mixed food stuff is no longer that of the un-carbonated provided that the designed volume of carbon dioxide is dissolved in the mixed food stuff at a food safe level of about 3 vols minimum, and
(e) packaging the said carbonated mixed food stuff of said claim 33 in shelf stable closed containers capable of retaining a degree of carbonation without refrigeration wherein the steps of flavoring composition comprising:
(1) adding sugar, sugar cane, corn syrup and sweet of said claim 22, and sour, bitter, salty and umami foodstuff ingredients, and or discretionary calorie allowance group of said claim 14 mixing for a minimum of 5 minutes, and
(2) adding flavoring of flavor group of said claim 15, colors and additives of claim 23, thereof mixing for a minimum of 5 minutes, and
(3) adding calcium supplementation and vitamin supplementation of said claim 23 and mixing for a minimum of 2 minutes, and
(4) adding phosphoric acid and citric acid of said claim 23 and mixing for minimum of 2 minutes, and
(5) adding preservatives and stabilizers of said claim 23 and mixing for a minimum of 5 minutes, wherein the calcium supplementation includes benzoate, the preservations includes benzoic acid and the stabilizers include kappa-carageenan, and
(6) heated, pasteurized, sterile, flavored, and packaging non-carbonated mixed food group meal of said claim 33 can be cooled packaged sterile in shelf stable containers without refrigeration and determined to be a non carbonate meal that is safe for human consumption.

36. A process of claim 1, wherein a dietary intake meal plan of mixing food group meals of said claim 33 and, or claim 35, of liquid, slurry, puree, carbonate, and or non-carbonate ingredients at substantially room temperature for a period to form slurry, dough and, or batter composition comprising:
(a) wherein mixed food group meal of said claim 33 and, or said claim 35 of liquid, slurry, puree, carbonate and un-carbonate ingredients at substantially room temperature is present in the amount to contribute to the whole of the meal design, and
(b) wherein if needed warmed water is present in the amount to contribute to the whole of the meal design, and
(c) wherein if needed at least one or a combination of options of flours of said claim 17 is present in the amount to contribute to the whole of the meal design, and
(d) wherein if needed said claim 23, additives, which includes flavours, colors, and preservatives is present in the amount to contribute to the whole of the meal design, and
(e) wherein if needed said claim 18, which includes leavening agent is present in the amount to contribute to the whole of meal design, and
(f) wherein if needed at least one or a combination of baking oils of said claim 19 is present in the amount to contribute to the whole of the meal design, and
(g) wherein if needed at least one or a combination of baking salts of said claim 22 is present in the amount to contribute to the whole of the meal design, and
(h) wherein if needed at least one or a combination of baking sugars of said claim 22 is present in the amount to contribute to the whole of meal design, and
(i) wherein if needed at least one or a combination of options of food group of said claim 14 is present in the amount to contribute to the whole of the meal design, and
(j) wherein if needed a special sequence of adding each baking article is present in the amount to contribute to the whole of meal design,
(k) wherein if needed required items are mixed to form slurry, dough and, or batter of said claim 20, is present in the amount to contribute to the whole of the meal, and
(l) wherein if needed proofing the dough or batter for a sufficient time to form structure for baking is present in the amount to contribute to the whole of the meal.

37. A method according to claim 1, wherein at least one method of baking a shelf stable mixed food group meal of said claim 36 composition comprising:
(a) wherein mixed food group dough of said claim 36 is present and made shelf stable by at least one design of a shelf stable method of said claim 24 is present in the amount to contribute to the whole of the meal, and
(b) wherein at room temperature, food group meal slurry, dough and, or batter of said claim 36 is present in the amount to contribute to the whole of the meal design, and
(c) wherein a preheated oven to a minimum of at least 40 degrees centigrade, is present in the amount to contribute to the whole of the meal design, and
(d) wherein a baking container is prepared by lightly greasing or applying a release agent and, or dusting with flour of said claim 17 is present in the amount to contribute to the whole of the meal design, and
(e) wherein placing said mixed food group meal slurry, dough and, or batter of said claim 36 in said baking container is present in the amount to contribute to the whole of the meal design, and
(f) wherein baked said mixed food group meal of said claim 36 in said preheated oven until a toothpick or similar device inserted into the center comes out clean, is present in the amount to contribute to the whole of the meal, and
(g) wherein remove said baking container from said oven and allow to cool for at least 5 minutes, and package in air sealed container, and baked food group meal of said claim 36 is safe for human consumption.

38. A process of claim 1, wherein at least one method of making a shelf stable flaked cereal meal of mixed food group meal of said claim 36 composition comprising:
(a) wherein mixed food group dough of said claim 36 is present to contribute to the whole of the meal, and
(b) wherein, dried milled and, or whole grains of said claim 16 are present and processed as specially sized pieces know as flaking grits, and the grain is mixed with ingredients of said claim 36, is present to contribute to the whole of the meal and
(c) wherein the mixture is then load into a steam heated, rotating pressure cooker, and cooked to a specific moisture content, and present to contribute to the whole of the meal, and
(d) wherein a process of the cooked batch is discharged onto a conveyor which carries it to an apparatus of which the lumps of cooked swollen grain of the individual grits are broken apart is present to contribute to the whole of the meal, and
(e) wherein a process of drying individual grits under controlled heat and humidity to a level of about 10% to 17% is present to contribute to the whole of the meal, and
(f) wherein a process of drying the individual grits for several hours called tempering is present to contribute to the whole of the meal, and
(g) wherein after tempering the grits are flatten to a desired thinness, this process is known as flaking is present to contribute to the whole of the meal, and
(h) wherein resulting flakes are conveyed to ovens where they are placed in a blast of hot pressurized air to remove moisture and toasted, or cooked to desired color and flavor, such that the finished flakes have a moisture range of about 1% to 3%, is present to contribute to the whole of the meal.

39. A method according to claim 1 wherein one method of making a self stable shredded cereal meal of mixed food group of said claim 36 composition comprising:
(a) wherein dried milled and, or whole grain of said claim 16 is present and to contribute to the whole of the meal, and
(b) wherein shredding the process of mixing and cooking cleaned whole wheat grain with mixed food group of said claim 36, is present to contribute to the whole of the meal, and
(c) wherein the cooked grain is cooled in holding bins and allowed to temper, and flatten to the desired thickness, to contribute to the whole of the meal, and
(d) wherein the cooked grain is shredded and dropped off on a roller into a continuous ribbon wherein shredded webs are layered, is present to contribute to the whole of the meal, and
(e) wherein the layered webs are cut, severed and joined together as biscuits are present to contribute to the whole of the meal, and
(f) wherein the layered cut biscuit is baked down to a moisture level below 5% is present to contribute to the whole of the meal.

40. A method according to claim 1, wherein at least one method of making a shelf stable puffed cereal meal composition comprising:
(a) wherein the milled dried grain and or whole grain of said claim 16, is present in the amount to contribute to the whole of the meal, and
(b) wherein puffing the process starts by mixing cleaned grain with ingredients of the mixed food group of said claim 36, and the two are cooked, dried, and bumped is present to contribute to the whole of the meal, and
(c) wherein bumped a process where the mixture is only partially flattened to desired thinness, is present in the amount to contribute to the whole of the meal, and
(d) wherein the bumped mixture is dried again and place in a oven until it swells to desired thickness, is present in the amount to contribute to the whole of the meal, and
(e) wherein if needed a process of pearling, is used in which the grain mixture is treated to partially remove the outer layer of bran by abrading it off is present in the amount to contribute to the whole of the meal, and
(f) wherein the bran may also be removed by soaking the mixture in salt water, is present in the amount to contribute to the whole of the meal, and
(g) wherein the mixed grain is placed in a puff gun, a small vessel which holds hot steam at very high pressures and when opened the gun pushes the steamed air which puffs the grain is present in the amount to contribute to the whole of meal, and
(h) wherein extruded pellets can also be used to make gun puffed cereal meals in the same way as grains in the amount to contribute to the whole of the meal.

41. wherein a process of claim 1, wherein a method of coating and packing is present to contribute to the whole of cereal meal with composition comprising:
(a) wherein after shaping, puffing and shredding, the cereal meals of said claims 38 thru claim 40 if needed may be spray coated with vitamins, minerals, sweeteners, flavors, hot syrup of sugars, and, or add at least one or a combination of dried fruit group, dried vegetable, dried grain, dried meat and beans, dried discretionary group, dried milk group, dried oil group, all from food groups of said claim 14, are present to contribute to the amount of the whole of the meal and packaged in airtight, waterproof plastic bags within cardboard boxes and considered safe for human consumption.

42. The process of claim 1, wherein a method of making an instant freeze dried meal of mixed food stuff of said claim 33 and said claim 35 composition comprising:
(a) slurry, carbonate and or non carbonate food stuff of said claim 33 and claim 35 are present in the amount to contribute to the whole of the meal, and
(b) wherein a small amount of aroma oil is added to the said slurry, carbonate, and, or non carbonate foodstuff, and they are placed and mixed into shallow pans, to contribute to the whole of the meal, and
(c) wherein the pans are placed in a cold room where temperature is about minus 40 degree centigrade and remain there until mixed food stuff freezes, to contribute to the whole of the meal, and
(d) wherein the frozen mixed food is place into a low temperature grinder, and ground up into small particles, to contribute to the whole of the meal, and
(e) wherein the ground particles are placed in a drying chamber where the vacuum pumps evacuate the air and reduces the pressure to about 0.036 pounds per square inch, to contribute to the whole of the meal, and
(f) wherein the next procedure known as sublimation must take place in which the ice crystals in the frozen food stuff pieces are forced to change into water vapor without becoming liquid water therefore the temperature of the mixed food stuff must be raised to about 38 degree centigrade to contribute to the whole of the meal, and
(g) wherein to assure sublimation, direct conduction through the bottom of the pans, using radiation from heat lamps or microwave heating, is present to contribute to the whole of the meal, and
(h) wherein the drying chamber is evacuated of air forcing the pressure to drop below the threshold at which water can simultaneously exit in a solid, liquid and vapor state causing the ice crystals trapped in the frozen pieces of mixed food stuff to change to water vapor, is present to contribute to the whole of the meal, and
(i) wherein the vapor is drawn off and condensed within the chamber leaving dried food behind to contribute to the whole of the meal, and
(j) wherein the dried food is filled with tiny voids, that act like sponges where the ice crystal were once present, and wherein the dried food pieces are removed from the drying chamber and tested for moisture and purity, and wherein the freeze dried mixed food stuff pieces are packaged and sealed in airtight container and determine safe for human consumption.

43. The process of claim 1, wherein at least one method of making a chocolate meal of mixed food stuff said claim 33 and claim 35 composition comprising:
(a) wherein mixed food group of said claim 33 and said claim 35 are present in the amount to contribute to the whole of the meal, and
(b) wherein clean cocoa beans are roasted on screens, and roasted again in revolving cylinders through which heat is blown over the beans to obtain a moisture content of about 1% to 5%, this process takes about 30 minutes to about 3 days is present to contribute to the whole of the meal, and
(c) wherein while roasting the bean shells and the nibs are cracked, and then separated by a winnowing machine, sometimes called cracker and fanner, is present to contribute to the whole of the meal, and
(d) wherein the roasted nib undergoes a broyage, a process in which the bean shell is discharged, and the nib is crushed by grinding wheels to liquefy the cocoa butter, what is now called chocolate liquor or chocolate liquid is present to contribute to the whole of the meal, and
(e) wherein the chocolate liquid is placed in a conch machine with the mixed foodstuff of said claim 33 and, or said claim 35, is present to contribute to the whole of the meal, and
(f) wherein the conch machine rollers or paddles continuously knead the mixed chocolate liquid mass about 3 hours to 3 days depending on the flavor texture desired is present to contribute to whole of the meal, and
(g) wherein the mass is poured into molds and tempered and then molded into desired shape, then it is cooled, cut, wrapped and the chocolate meal is determined safe for human consumption.

44. A method according to claim 1, wherein at least one method of making a shelf stable caramel mixed food group meal of said claim 36 composition comprising:
(a) wherein mixed food group of said claim 36 is present and if needed least one design of a shelf stable method of said claim 24 is present in the amount to contribute to the whole of the meal, and
(b) wherein at least one or a combination of sugar of said claim 22 is heated to a pre determined temperature of about 100 to 170 degree centigrade in water in a batching and dissolving machine to contribute to the whole of the meal, and
(c) wherein the dietary intake meal of said claim 36 is added gradually and sequencelly so that the mixture continues to melt as the agitation thoroughly dissolves the entire mixture to the desired color to contribute to the whole of the meal, and
(d) wherein the heated mixture is then sent to a surge tank to complete the evaporation process, the mixture is forced through small tubular spaces thus forcing the evaporation within the mixture to contribute to the whole of the meal, and
(e) wherein the evaporated mixture is fed into a steam jacketed caramelizing tank with temperatures of about 116 to 170 degree centigrade where the mixture is re-circulate from the bottom to the top of the tank with the incoming syrup mixing with caramelizing slurry, thus promoting homogeneity to contribute to the whole of the meal, and
(f) wherein the caramel meal mixture is discharged through control valves directing it to a processing machine for cooling, to contribute to the whole of the meal, and
(g) wherein the caramel meal is cooled by moving it into cool rooms and running it through cooling tunnels and or cooling wheels in which the caramel is laid in a film about 3.2 millimeter thick and water cooled on the outside surface of a wheel which is about one to five feet in diameter to contribute to the whole of the meal, and
(h) wherein the caramel meal comes off the wheel, becoming solid and of a consistency such that it may be cut and packaged, to contribute to the whole of the meal, and
(i) wherein a batch roller takes the caramel meal film and shapes it into a rope, and the rope is then shaped and sized into the thickness, of a finished caramel meal, weighed and placed in a sealed bag and packed into cartons for shipping and determined safe for human consumption.

45. The process of claim 1, wherein a method of making a frozen dehydrated meal of mixed food stuff said claim 33 and claim 35 composition comprising:
(a) wherein molds are washed, rinsed, heated, and sanitized before receiving mixed foodstuff, after washing the molds are reinverted so they can be filed with refrigerated mixed foodstuff, to contribute to the whole of the meal, and
(b) wherein mixed foodstuff of said claim 33 and said claim 35 are set in a sterilized vat and refrigerated to about 1.7 to 2.8 degrees centigrade, such that it does not quit reach the freezing point is present to contribute to the whole of the meal, and
(c) wherein said mixed food stuff is pumped to a machine called a vita-line or equivalent which houses and transports sets of said molds through several process to form the frozen dehydrated meals is present to contribute to the whole of the meal, and
(d) wherein refrigerated mixed food stuff is pumped through sets of nipples into the molds and the molds are pulled into a tank filled with water containing calcium chloride that is ammonia cooled to about minus 32 to minus 34 degree centigrade to contribute to the whole of the meal, and
(e) wherein as the molds are drawn along the length of the tank the refrigerated mixed food stuff changes from liquid to a frozen state, and injector pushes the sticks into the frozen pops, which freezes from the outside toward the center and supports the stick, to contribute to the whole of the meal, and
(f) wherein the molds then passes briefly through a tank containing about 68 degree centigrade water that slightly heats the mold as an extractor bar pull the popsicle meals out of their molds by their sticks, and if the popsicle meals are to be dipped the extractor dips popsicle meals into a dip tank and a coating is flash frozen to contribute to the whole of the meal, and
(g) wherein the extractor bar carriers the popsicle meal to packaging area where they are bagged and boxed and remain frozen and determined safe for human consumption.

46. The process to claim 1 wherein a menu of mixed ingredients is present with composition comprising:
(a) milkfat, of 0.0 to 99.0%, and
(b) milk solids, not fat of 0.0% to 99.0%, and
(c) skim milk, 0.0 to 99.0%, and
(d) whey and or soy, of 0.0 to 99.0%, and
(e) gelatin, of 0.0 to 99.0%, and
(f) buttermilk, of 0.0 to 99.0%, and
(g) lactose, of 0.0 to 99.0%, and
(h) sweeteners, of 0.0% to 99.0%, and
(i) stabilizers and, or emulsifiers, of 0.0 to 99.0%, and
(j) water, of 0.0 to 99.0% which comes from the milk or other ingredients, and
(k) starter culture, of 0.0 to 99.0% and
(l) flavours and, or colours, of 0.0 to 99.0%.

47. A method according to claim 1 wherein at least one method of making an ice cream, a yogurt, a frozen custard, a sherbet, a gelaton, a glace, a granite, and a antithesis meal mixed foodstuff of said claim 33 and said claim 35 composition comprising:
(a) wherein said mixed foodstuff of said claim 46 and mixed ingredients of said claim 33 and, or claim 35 thereof is present based on the desired formulations and calculations and blended per dietary intake menu plan of said claim 20 at room temperature is present to contribute to the whole of the meal, and
(b) wherein said blended mixed foodstuff is pumped from a holding container, tank to a surge, balance tank, in which the unit is controlled by valves that allows throttling the inlet flow is present to contribute to the whole of the meal, and
(c) wherein said blended mixed foodstuff is pumped, drawn into a regenerative heat exchanger or comparable industry standard apparatus which heats the mixed foodstuff for a predetermined time of at least 65 to 137 degrees centigrade for a time not to exceed about 10 seconds and, not to full pasteurization of said claim 34 temperature at this stage to contribute to the whole of the meal, and
(d) wherein said blended mixed food stuff wherein is cooled to a temperature less than about 10 degrees centigrade to contribute to the whole of the meal, and
(e) wherein said blended mixed foodstuff is pumped via a timing system such that the timing system is a single device or combination of devices which controls the maximum flow rate through the system, and the performance of the system relies on the mixed foodstuff passing through the system at a known controlled flow rate to contribute to the whole of the meal, and
(f) wherein said blended mixed foodstuff if needed passes through a apparatus having at least one said timing device of which to be but not limited to a positive displacement pump with a controlled speed drive, a homogenizer, or a centrifugal pump with magnetic flow meter controller to contribute to the whole of the meal, and
(g) wherein said blended mixed foodstuff is pumped by the timing system into a heat exchanger which heats the mixed foodstuff to the full pasteurization temperature of said claim 34, and the heating media can be but not limited to recycled hot water kept at desired temperature by direct injection of steam to contribute to the whole of the meal, and
(h) wherein said blended mixed food stuff passes through a hold tube of which the length, volume of the hold tube is specifically designed so that the time required for the mixed foodstuff to reach the end is the number of seconds required for full pasteurization of said claim 34 based on temperature and time is present to contribute to the whole of the meal, and
(i) wherein said blend mixed food stuff at the end of said hold tube a sensor measures the temperature such that if the temperature is at or above the required temperature, then the blended mixed foodstuff is considered fully pasteurized and is permitted to pass on further into the next process and too if mixed foodstuff is not up to temperature it is diverted back to the container or surge, balance tank and recycled to contribute to the whole of the meal, and
(j) wherein said blended mixed foodstuff if needed passes through a second apparatus having at least one timing device, of which to be but not limited to a positive displacement pump with controlled speed drive, a homogenizer, or a centrifugal pump with magnetic flow meter controller to contribute to the whole of the meal, and
(k) wherein said blended mixed foodstuff passes through a final heat exchanger which cools said foodstuff to a storage temperature to about less than 10 degree centigrade, generally with a cooling media of but not limited to chilled water, air blown, or food grade glycol to contribute to the whole of meal, and
(l) wherein said blended mixed foodstuff a process of ageing is performed in an insulated or refrigerated storage container with a temperature maintained at about 5 degree centigrade or as low as possible without freezing for at least 4 hours there by allowing time for the fat to cool down crystallize and for the proteins and polysaccharides to fully hydrate to contribute to the whole of meal, and
(m) wherein said blended mixed foodstuff a process of flavouring, in which the said blend is drawn into a flavor container with composition comprising but not limited to:
(1) wherein if desired at least one or a combination of options of mixed food stuff of said claim 25 thru 32, thereof is present in the amount to contribute to the whole of the meal design, and
(2) wherein if desired at least one or a combination of options of said additives dietary menu plan of said claim 23, is present in the amount to contribute to the whole of the meal design, and
(3) wherein if desired slurry, carbonate and, or non carbonate mixed foodstuff of said claim 33, and claim 35 is present in the amount to contribute to the whole of the menu design, and
(4) wherein if desired at least one or a combination of options of said flavor and taste group of said claim 32 and said claim 15 is present in the amount to contribute to the whole of the menu, and
(n) wherein said blended mixed foodstuff a process of dynamic freezing process which both freezes a portion of the water and whips air into the frozen mix whereby the freezer barrel is a scraped surface tubular heat exchanger, which is jacketed with a boiling refrigerant such as ammonia or freon, and the blended mix is pumped through the freezer and is drawn off the other end in a matter of about 30 seconds, or 10 to 15 minutes in the case of batch freezers, with about 50% of the water frozen to contribute to whole of the meal, and
(o) wherein said blended mixed foodstuff determined now to be ice cream antithesis meal wherein a process if needed of adding additional flavors as the said antithesis meal is drawn with about half of the water frozen particular matter such as fruits, nuts, candy, or other eatables of additives of said claim 23 is added to the semi frozen ice cream antithesis meal to contribute to the whole of the meal, and
(p) wherein ice cream antithesis after the particulars have been added the meal is packaged an placed into blast freezers at temperature of about minus 30 to minus 40 degree centigrade and be determined safe for human consumption.

48. A process of claim 1, wherein a dietary intake menu plan for a sandwich meal composition comprising:
(a) wherein baked meal of said claim 37 is present in the amount to contribute to the whole of the sandwich meal, and
(b) wherein a least one or a combination of menu plans of said claims 2 thru 13 is present in the amount to contribute to the whole of the said sandwich meal, and
(c) wherein at least one or a combination of milk group, grain group, fruit group, vegetable group, meat and beans group, oil group and discretionary calorie group of said claim 14 is present in the amount to contribute to the whole of the said sandwich meal.

49. A process of claim 1, wherein a dietary intake menu plan for a pizza sandwich meal composition comprising:
(a) wherein at least one or a combination of menu plans of said claims 2 thru 13 is present in the amount to contribute to the whole of the said pizza sandwich meal, and
(b) wherein a dietary intake meal plan of dough of said claim 36 is present to contribute to the whole of the said pizza sandwich meal, and
(c) wherein a dietary intake meal plan of pizza topping of said claim 15 is present to contribute to the whole of the said pizza sandwich meal, and
(d) wherein baked meal of said claim 37 is present in the amount to contribute to the whole of the said pizza sandwich meal.

50. The process of claim 1, wherein a method of coating, topping, dipping, insert filling, spreading is present in the amount to contribute to the whole of the various meal plans with composition comprising:
(a) wherein after being determined safe for human consumption non-carbonate beverage meal of said claim 35, carbonate beverage meal of said claim 35, baked meal of said claim 37, chocolate meal of said claim 43, caramel meal of said claim 44, freeze dried meal of said claim 42, dehydrated meal of said claim 45 ice cream meal of said claim 47, cereal meal of said claim 39 thru 41, pizza meal of said claim 48, sandwich meal of said claim 49, are present in the amount to contribute to the whole of the meal, and
(b) wherein said determined human consumption meals of claims 35 thru 49 to be coated, topped, dipped, insert filled and, or spreaded with proteins, vitamins, minerals, creams, chocolates, sweeteners, pastries, caramels flavors, and, or syrups of sugars, are present in the amounts to contribute to the whole of the meal.
